(19) United States
(12) Patent Application Publication
(10) Pub. No.: US 2014/0183136 A1
(43) Pub. Date: Jul. 3, 2014

(54) GRAFT COPOLYMER FOR CATION-EXCHANGE CHROMATOGRAPHY

(71) Applicant: MERCK PATENT GESELLSCHAFT MIT BESCHRANKTER HAFTUNG, Darmstadt (DE)

(72) Inventor: Heiner GRAALFS, Ober-Ramstadt (DE)

(73) Assignee: MERCK PATENT GESELLSCHAFT MIT BESCHRANKTER HAFTUNG, Darmstadt (DE)

(21) Appl. No.: 14/143,378

(22) Filed: Dec. 30, 2013

Related U.S. Application Data
(63) Continuation of application No. 12/601,979, filed on Nov. 25, 2009, now abandoned.

(30) Foreign Application Priority Data
May 25, 2007 (EP) 07010490.6

(51) Int. Cl. C08F 22/38; B01D 15/36

(52) U.S. Cl. CPC C08F 22/38; B01D 15/362
USPC 210/656; 521/38; 210/198.2

(57) ABSTRACT

The invention relates to chromatographic separating materials having improved binding capacity for biological constituents in cell culture supernatants, or animal or human body fluids, in particular for monoclonal antibodies. The present invention likewise relates to the preparation of separating materials of this type, and to the use thereof, in particular for the removal of charged biopolymers from corresponding liquids.

The invention relates to a separating material having improved binding capacity, to the preparation thereof, and to the use thereof for the removal of charged biopolymers from liquids.

### PRIOR ART

Chromatography is one of the most suitable methods for the isolation of proteins. Monoclonal antibodies can be purified, for example, by affinity chromatography using protein A ligands. Binding to the ligand from the cell culture supernatant is possible without adaptation of pH and salt concentration. Nevertheless, these sorbents can only be employed to a limited extent due to their high costs and due to bleeding-out of the ligand.

The use of high-capacity ion exchanger resins is a favourable alternative. However, the conduction value in the cell culture supernatant must be reduced in order that binding to the ion exchanger takes place. This can be carried out by desalination or by dilution of the supernatant. Both possibilities are undesired, in particular, in the case of large-volume production processes.

In the presence of salts (high conduction value), charges are masked. In order nevertheless to enable binding to an ion exchanger at relatively high conduction value, at least one second interaction between the protein and the chromatography support must be present in addition to the ionic interaction.

Separating materials which, besides an anionic group, contain further functional groups and bind biopolymers in the presence of salt are known from the literature.

U.S. Pat. No. 5,652,348 (Burton et al.) discloses chromatography resins and the use thereof which are obtained by hydrophobic modification of ionisable ligands using non-ionisable ligands. The binding here takes place under conditions which supports hydrophobic interaction. The desorption is carried out at a different pH, meaning that the resin becomes hydrophilic and attains a charge, and the bound protein (of the same charge) is repelled.

Burton et al. (Biotechnology and Bioengineering 1997, 56, 45-55) describe the purification of chymosin on a carboxyl matrix, which has been partially modified by coupling to an aromatic amine.

EP 1 094 899 discloses a method for the removal of biomolecules, in particular proteins, using cation exchangers, which is characterised in that the binding is carried out at >15 mS/cm and the elution is carried out at relatively high ion strength. The cation-exchanging ligand here is bound to a support matrix via the second functional group and a spacer.

U.S. Pat. No. 7,067,059 claims a process for the preparation of chromatography gels containing mixed-mode cation exchanger ligands, where the preparation is carried out using cyclic homocysteine compounds, which, due to ring opening, result in groups containing at least two functional groups.

U.S. Pat. No. 6,852,230 and EP 1 345 694 describe and claim the use of ion exchangers for the binding and removal of charged biomolecules having a peptide structure, where, after the desorption step, a salt-free or reduced-salt solution is present, so that desalination commences at the same time.

U.S. Pat. No. 7,008,542 claims a method for the removal of a substance, in particular bioorganic molecules having a molecular weight of greater than 1000 daltons, which is carried out using a support matrix. The latter contains at least two structurally different ligands, where at least one ligand is an ion exchanger. Typical ligands have a molecular weight of <1000 Da.

U.S. Pat. No. 7,144,743 describes a polycyclic ligand for chromatography which is substituted by an anionic group.

Functionalised linear polymers, which are obtained by grafting corresponding functionalised monomers onto a multiplicity of different surfaces, have been known for many years. If the functionalisation involves chemically bonded anionic groups, corresponding materials can be used for cation exchange chromatography (W. Müller, J. Chromatography 1990, 510, 133-140). A larger number of possible graft polymer structures which are intended for the fractionation of biopolymers is given in the patents EP 0 337 144 or U.S. Pat. No. 5,453,186. Graft polymers comprising more than one monomer unit which are obtained by copolymerisation are also known from the patent literature. However, the combination of the monomers is only discussed briefly in the literature: In order to obtain suitable exchangers, the monomers for the copolymerisation must then be selected so that both monomers contain either basic or acidic groups or one of the monomers is neutral. Ternary monomer mixtures or chemical modifications of the graft polymers are not explicitly mentioned.

The interaction between proteins and free, or soluble, synthetic polyelectrolytes, such as, for example, of hydrophobically modified poly(acrylic acid) and BSA, has been investigated and discussed in Biomacromolecules 2003, 4, 273-282.

Many approaches for the modification of cation exchangers are thus known from the patent and journal literature. Various methods are also known for the preparation of adsorbents containing ligands which work with mixed mode. However, there are only a few commercially available adsorbents which are suitable for binding proteins and in particular antibodies from cell culture supernatants.

The chromatography gel described in U.S. Pat. No. 7,144,743, which is derivatised by means of 2-mercapto-5-benzimidazolesulfonic acid as ligand, can bind up to 30 mg/ml of IgG. Our own measurements with Gammanorm using a corresponding product which is commercially available under the name MBI HyperCel® have shown binding of 23 mg/ml at pH 5 and 140 mM NaCl (10% breakthrough).

In the case of another product marketed by the same company, hydrophobic charge induction chromatography (HCIC) is used. Using this product, up to about 32 mg/ml of polyclonal human IgG can be bound.

On use of another commercially available product which is marketed under the name Capto MMC®, a dynamic binding capacity (10% breakthrough) of 7 mg/ml at pH 5.5 and 150 mM NaCl was found for human IgG. A multimodal ligand is used for the preparation of the product described in U.S. Pat. No. 7,067,059. However, this gel was not developed especially for antibodies and binds 45 mg/ml of BSA.

In addition, there are further commercially available products containing synthetic ligands which are only able to bind antibodies from buffer solutions. On use for the treatment of cell culture supernatants, unsatisfactory or no binding are obtained. This result is probably caused by components in the cell culture supernatant which have an interfering behaviour.

There continues to be a demand for the provision of adsorbents for the purification of antibodies which have advantages with respect to capacity, throughput, economic efficiency or selectivity (J. Chromatography B 2007, 848, 48-63). Polymers are per se highly suitable for the surface modification of chromatography supports since a wide choice of functional groups, in particular also for the synthesis of multifunctional materials, is available, and it is possible to build up thick layers containing a large number of functional groups. In particular, high-capacity chromatography materials can be produced by covering the surface with a “soft” polymer layer (J. Chromatography 1993, 631, 107-114).

However, no separating materials are known to date which can be prepared by a process which is simple to carry out using inexpensive starting materials and which have such high separation activities, in particular with respect to monoclonal antibodies, on use for the separation of cell culture supernatants or other biological liquids without significant reduction in the conductivities that they would be suitable for use on an industrial scale.

### OBJECT

The object of the present invention is therefore to provide a separating material which has improved binding capacities for proteins, in particular also for antibodies from cell culture supernatants, and is suitable for use on an industrial scale for preparative applications.

In particular, the object of the present invention is therefore to prepare materials which, at a conduction value as is usually present in cell culture supernatants, have higher protein binding capacities under otherwise identical conditions than cation exchangers commercially available to date, such as, for example, Fractogel® EMD SO₃⁻ (M) or Fractogel® EMD COO⁻ (M). The protein binding capacities here should be high with good recovery of the protein employed if the protein has only a short contact time with the separating material, in particular under dynamic conditions, as are present in chromatographic processes at relatively high flow rates. The aim of the present invention is thus the synthesis of a salt-tolerant cation exchanger and the use thereof in protein purification.

An additional object of the present invention is to provide an alkali-stable separating material by means of which purification or regeneration is facilitated at pH≧13 without significantly changing the properties of the separating material.

### ACHIEVEMENT OF THE OBJECT ACCORDING TO THE INVENTION AND SUBJECT-MATTER OF THE INVENTION

The object of the present invention is achieved by the provision of a novel separating material which can be prepared by derivatisation of the surface of a hydroxyl-containing inorganic, organic or hybrid support material by covalently bonded copolymers, where the copolymers are graft polymers built up from at least two different monomer units, and where at least one of these monomer units contains a functional group having a negative charge and at least one of these monomer units contains a hydrophobic group which imparts a hydrophobic character on the copolymer in addition to the negative charge. The characteristic feature of the graft polymer bound to the surface of the separating material is that it can be prepared using at least one monomer unit which contains at least one carboxyl and/or sulfonic acid group as negatively charged groups and in addition contains ester or amide groups and alkyl and/or alkylene groups having in total a maximum of 8 C atoms, but no aryl groups. Another variant is that it carries a negative charge in the form of a sulfonic acid or carboxylic acid and in addition contains alkyl and/or alkylene groups, but no aryl groups. Furthermore, the copolymer comprises, inter alia, at least one monomer unit which carries a straight-chain or branched alkyl having 4 to 18 C atoms or corresponding aryl groups as hydrophobic group and contains ester or amide groups. The graft polymer bonded to the support material is built up from monomer units which had a molar ratio of the monomer units having a negative charge to the monomer units containing hydrophobic groups in the range from 99:1 to 10:90. The preparation of the graft polymer covalently bonded to the surface of the separating material in the form of a copolymer is preferably carried out using at least one water-soluble monomer unit having a negative charge of the general formula (1)

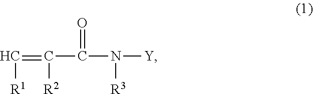

in which
R¹, R² and Y, independently of one another,
denote H or CH₃,
   R³ denotes R⁴—SO₃M or R⁴—COOM,
   R⁴ denotes straight-chain or branched alkylene having 2 to 4
   C atoms and
   M denotes H, Na, K or NH₄
   or of the general formula (2)

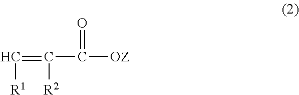

in which
R⁷ and R⁸, independently of one another,
denote H or CH₃, or
   R⁷ denotes COOM if Z=M and R⁸=H,
   Z denotes either M, R⁴—COOM or R⁴—SO₃M, where
   R⁴ denotes straight-chain or branched alkylene having 2 to 4 C atoms,
   and
   M denotes H, Na, K or NH₄,
   or at least in each case one monomer unit of the general formula (1) and a monomer unit of the general formula (2)
   and at least one further monomer unit containing a hydrophobic group of the general formula (1), which imparts a hydrophobic character on the copolymer and in which
   R¹ denotes H or COOM,
   R² denotes H or CH₃,
   Y and R³ denote straight-chain or branched alkyl having up to 18 C atoms,
in which Y and R³ together carry at least 6 C atoms,
   or
   Y denotes H
   and
   R³ denotes straight-chain or branched alkyl having 6 to 18 C atoms or
   Y denotes H
   and
   R³ denotes aryl or R⁶-aryl or
   Y denotes H or CH₃
   and
   R³ denotes R⁴—CONHX,
   X denotes straight-chain or branched alkyl having 6 to 18 C atoms,
aryl or R⁶-aryl
   R⁴ denotes straight-chain or branched alkylene having 2 to 4 C atoms
   R⁶ denotes a straight-chain or branched alkylene having 1 to 4 C atoms, in which a methylene group may be replaced by O and may be substituted by COOM
   and
   M denotes H, Na, K or NH₄
   or a corresponding monomer unit containing a hydrophobic group of the general formula (2),
   in which
   R⁷ denotes H,
   R⁸ denotes H or CH₃,
   Z denotes straight-chain or branched alkyl having 4 to 18 C atoms,
aryl, R⁶-aryl or R⁴—CONHX,
   X denotes straight-chain or branched alkyl having 6 to 8 C atoms,
aryl, R⁶-aryl,
   and
   R⁶ denotes a straight-chain or branched alkylene having 1 to 4 C atoms
   and
   where the molar ratio of the monomer units having a negative charge to the monomer units containing a hydrophobic group is in a range between 99:1 to 10:90.

A covalently bonded graft polymer of this type can likewise be prepared using at least one water-soluble monomer unit of the general formula (1)

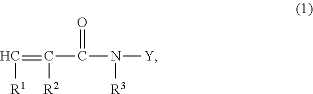

or of the general formula (2)

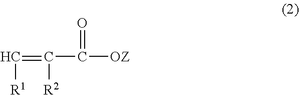

in which
Y denotes R⁵—COOM
R¹ and R², independently of one another,
   denote H, straight-chain or branched alkyl having 1 to 6 C atoms, carboxyl, carboxymethyl
R³ denotes H, straight-chain or branched alkyl having 1 to 6 C atoms, Y
R⁵ denotes straight-chain or branched alkylene having up to 8 C atoms, optionally mono- or polysubstituted by alkoxy or carboxyl groups
   or/and
   arylene having up to 10 C atoms, optionally mono- or polysubstituted by alkyl, alkoxy or carboxyl groups
      and
M denotes H, Na, K or NH₄ and
Z denotes M or Y.

In addition, separating materials of this type can also be prepared using at least one water-soluble monomer unit of the general formulae (1) or (2) in which
Y denotes R⁴—SO₃M
   and
R¹ and R², independently of one another,
   denote H, straight-chain or branched alkyl having 1 to 6 C atoms and
R³ denotes H, straight-chain or branched alkyl having 1 to 6 C atoms and
R⁴ denotes methylene, ethylene, propylene, hexylene, isopropylene, isobutylene or phenylene.

The radical Y of the water-soluble monomer unit of the general formula (1) or formula (2) employed may also adopt the following meaning:
Y denotes R⁵—COOM,
   where simultaneously
R¹ and R², independently of one another,
   denote H, straight-chain or branched alkyl having 1 to 6 C atoms and
R³ denotes H, straight-chain or branched alkyl having 1 to 6 C atoms and
R⁴ denotes methylene, ethylene, hexylene, propylene isopropylene, isobutylene or phenylene.

Particular preference is given to separating materials of this type which comprise copolymers which comprise at least two different monomer units and where the copolymers comprise in each case at least one monomer unit having a negative charge selected from the group 2-acrylamido-2-methylpropanesulfonic acid, 2-acrylamidoethanesulfonic acid, carboxymethylacrylamide, carboxyethylacrylamide, carboxypropylacrylamide, carboxymethylmethacrylamide, carboxyethlymethacrylamide, carboxypropylmethacrylamide, maleic acid, acrylic acid and methacrylic acid and in each case at least one monomer unit containing a hydrophobic group of the general formula (1)

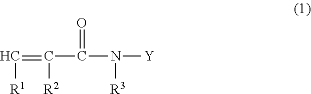

in which
R¹ denotes H,
R² denotes H or CH₃,
Y denotes H
   and
R³ denotes aryl or R⁶-aryl,
   or
Y denotes H or CH₃
   and
R³ denotes R⁴—CONHX where
X denotes aryl or R⁶-aryl,
R⁴ denotes methylene, ethylene, propylene and
R⁶ denotes a straight-chain or branched alkylene having 1 to 4 C atoms, in which a methylene group may be replaced by —O— and may be substituted by COOM
   and
M denotes H, Na, K or NH₄.

Preference is furthermore given to separating materials of this type in which the copolymer comprises at least one monomer unit having a negative charge selected from the group 2-acrylamido-2-methylpropanesulfonic acid, 2-acrylamidoethanesulfonic acid, carboxymethylacrylamide, carboxyethylacrylamide, carboxypropylacrylamide, carboxymethlymethacrylamide, carboxyethlymethacrylamide, carboxypropylmethacrylamide, maleic acid, acrylic acid and methacrylic acid and the copolymer comprises at least one monomer unit containing a hydrophobic group of the general formula (1)

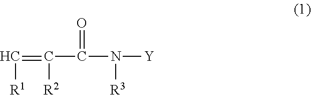

in which
R¹ denotes H,
R² denotes H or CH₃,
Y denotes H
   and
R³ denotes phenyl, benzyl, phenylethyl or phenoxyethyl,
   or
Y denotes H or CH₃
   and
R³ denotes R⁴—CONHX, where
X denotes phenyl, benzyl, or phenylethyl,
   and
R⁴ denotes methylene, ethylene, propylene, acryloylphenylglycine or acryloylphenylalanine.

Corresponding separating materials which have been prepared using at least one compound selected from the group of the methacrylamides, the acrylamides or the unsaturated carboxylic acids have particularly advantageous properties.

The present invention relates, in particular, to separating materials, as described above, for the preparation of which at least one compound selected from the group of the sulfoalkyl acrylates, such as 3-sulfopropyl acrylate or 2-sulfoethyl acrylate, vinylsulfonic acid, styrenesulfonic acid, allylsulfonic acid and, vinyltoluenesulfonic acid or from the group of the sulfoalkyl methacrylates, such as 2-sulfoethyl methacrylate or 3-sulfopropyl methacrylate, is employed.

However, at least one compound selected from the group maleic acid, cinnamic acid, itaconic acid, citraconic acid, mesaconic acid, or fumaric acid or the group of the carboxyalkyl acrylates, such as carboxyethyl acrylate, or the carboxyalkyl methacrylates can also be employed in accordance with the invention for the preparation of suitable, derivatised separating materials.

Separating materials which are highly suitable for the purpose according to the invention can, in addition, be prepared using at least one compound selected from the group carboxymethylacrylamide, carboxyethylacrylamide, acryloyl-gamma-aminobutyric acid and acryloylphenylalanine, acrylic acid, methacrylic acid and ethacrylic acid.

Particular preference is given to separating materials which comprise a covalently bonded graft polymer on the surface, prepared using at least one monomer unit which has a pronounced hydrophobic content in the form of at least one alkyl or aryl group having a suitable number of carbon atoms. Separating materials of this type have proven particularly effective in accordance with the invention owing to the possibility of interacting with the biopolymer to be removed both by means of the hydrophobic content and also by means of the charged content of the graft polymer.

Consequently, derivatisation using at least one monomer unit having a hydrophobic content, selected from the group of the alkyl vinyl ketones, aryl vinyl ketones, arylalkyl vinyl ketones, styrene, alkyl acrylates, aryl acrylates, arylalkyl acrylates, alkylaryl acrylates, alkyl methacrylates, aryl methacrylates, arylalkyl methacrylates and alkylaryl methacrylates is particularly desirable.

Particularly effective separating materials can also be prepared using at least one monomer unit of the general formula (1) having a hydrophobic content, in which Y=R⁶

and in which
R¹ and R², independently of one another,
denote H, unbranched or branched alkyl having up to 6 C atoms
   R³ and/or R⁶, independently of one another,
denote H, unbranched or branched alkyl, aryl,
alkylaryl, arylalkyl,
where the alkyl group may carry oxo groups,
where the alkyl and/or aryl group may be
mono- or polysubstituted by alkoxy, phenoxy, cyano, carboxyl, acetoxy or acetamino groups,
and where R³ and R⁶ together carry at least 6 C atoms.

Separating materials in accordance with the present invention can therefore be prepared using at least one monomer unit of the general formula (1) having a hydrophobic content, in which

R³, R⁶, independently of one another,
denote H, methyl, ethyl, propyl, butyl, pentyl, hexyl, heptyl, octyl, nonyl, decyl, 2-, 3-, or 4-oxapentyl, 2-, 3-, 4- or 5-oxahexyl, 2-, 3-, 4-, 5- or 6-oxaheptyl, 3-butoxypropyl, isopropyl, 3-butyl, isobutyl, 2-methylbutyl, isopentyl, 2-methylpentyl, 3-methylpentyl, 2-oxa-3-methylbutyl, 2-methyl-3-oxahexyl, 2-phenyl-2-oxoethyl, phenoxyethyl, phenyl, benzyl, phenylethyl and phenylpropyl
and where R³ and R⁶ together carry at least 6 C atoms.

Separating materials according to the invention are accordingly preferably prepared using at least one of these monomer units containing a functional group having a negative charge and at least one monomer unit which contains a hydrophobic group which imparts a hydrophobic character on the copolymer besides the negative charge, and optionally at least one neutral monomer unit, which may be hydrophilic.

Particular preference is given to separating materials of this type which have been prepared using at least one neutral monomer unit, of the general formula (1), which may be hydrophilic,

where Y=R⁶ and in which
R¹, R², independently of one another, denote H or methyl
R³, R⁶, independently of one another,
denote H, alkyl, alkoxyalkyl, each having up to 4 C atoms.

Very particular preference is given to separating materials containing at least one neutral monomer unit, which may be hydrophilic, of the general formula (1) where Y=R⁶, in which

R¹, R², independently of one another, denote H or methyl
R³, R⁶, independently of one another,
denote H, methyl, ethyl, butyl, isopropyl, 3-butyl, isobutyl, methoxyethyl or ethoxyethyl.

For the preparation of the separating material, at least one neutral monomer unit selected from the group acrylamide (AAm), dimethylacrylamide, methacrylamide, isopropylacrylamide, methoxyethylacrylamide and ethoxyethylacrylamide or from the group methyl acrylate and methyl methacrylate can therefore be employed, and using two or three monomers selected from the group 2-acrylamido-2-methylpropanesulfonic acid, acrylic acid, N-arylalkylacrylamides, such as benzylacrylamide and acryloylphenylalanine, N-carboxyalkylacrylamides, such as acryloyl-gamma-aminobutyric acid, and N-alkylacrylamides.

The present invention relates, in particular, to separating materials, as described above, in which the molar ratio of the units which carry negative charges to the units containing aromatic groups is in a range between 99:1 to 10:90, preferably in a range between 96:4 to 40:60.

In turn here, separating materials whose copolymer comprises 2-acrylamido-2-methylpropanesulfonic acid or/and 2-acrylamidoethanesulfonic acid as monomer unit(s) having a negative charge and in which the molar ratio of the monomer units having a negative charge to the monomer units containing a hydrophobic phenyl, benzyl or phenylethyl group is in a range between 70:30 to 30:70 have particularly good properties.

Further separating materials having particularly good properties are those in which the copolymer comprises acrylic acid or/and methacrylic acid as monomer unit having a negative charge, and in which the molar ratio of the monomer units having a negative charge to the monomer units containing a hydrophobic phenyl, benzyl or phenylethyl group is in a range between 95:5 to 70:30.

In addition, separating materials of this type in which the copolymer comprises a monomer from the series 2-acrylamido-2-methylpropanesulfonic acid and 2-acrylamidoethanesulfonic acid as monomer unit having a negative charge and a monomer from the series acrylic acid and methacrylic acid and the molar ratio of the monomer units having a negative charge to the monomer units containing a hydrophobic phenyl, benzyl or phenylethyl group is in a range between 95:5 to 30:70 have proven very good on use.

The present object is achieved, in particular, by separating materials in which the proportion of charged groups of the poly(acrylamide) graft polymers covalently bonded to the surface which contain only sulfonic acid groups as charged groups is in the range from 35 to 70 mol % in relation to the total amount of graft polymer. The object according to the invention can furthermore be achieved by corresponding separating materials in which the proportion of charged groups of the graft polymers which contain only carboxyl groups as charged groups is in the range from 60 to 98 mol % in relation to the total amount of graft polymer.

The separating materials according to the invention are particularly highly suitable for use in chromatography columns. The present invention thus also relates to chromatography columns which contain the separating materials according to the invention described.

In particular, the separating materials characterised here are also particularly highly suitable for the removal of biopolymers from liquid media.

It has proven particularly advantageous that biopolymers can be adsorbed simply and effectively from a liquid having an electrolytic conductivity which is higher than 6 mS/cm preferably higher than 9 mS/cm, by means of these separating materials, whereas corresponding biopolymers in an aqueous liquid which has an electrolytic conductivity in the range from 1 to 20 mS/cm and a pH greater than 4 is in dissolved form or can be desorbed. These separating materials are thus suitable for adsorbing antibodies from an aqueous liquid having a pH of 5.5 and having an electrolytic conductivity which is higher than 6 mS/cm, preferably higher than 9 mS/cm, and can thus be used in a simple manner for removal from biological liquids. The loaded separating material can subsequently be treated and the biopolymer eluted with a suitable liquid.

The present invention thus also relates to the use of the characterised separating material for the removal of a biopolymer from a liquid by desorbing the biopolymer bonded to the separating material by interaction with the ionic and optionally the hydrophobic groups, either by increasing the ion strength and/or by modifying the pH in the solution and/or through the use of an eluent having a different polarity to that of the adsorption buffer.

A suitable process for the preparation of such separating materials according to the invention is carried out by graft-polymerising at least one monomer unit containing a functional group having a negative charge with at least one monomer unit containing a hydrophobic group, and optionally with a neutral monomer having hydrophilic properties, on a hydroxyl-containing inorganic, organic or hybrid support material in a one- or two-step reaction. For this purpose, for example, at least one monomer unit containing a functional group having a negative charge is dissolved in dilute acid with at least one monomer unit containing a hydrophobic group, and optionally a neutral monomer having hydrophilic properties, with addition of a cosolvent in the presence of cerium(IV) ions and graft-polymerised on a hydroxyl-containing inorganic, organic or hybrid support material.

The process according to the invention for the preparation of the separating materials characterised above is, in particular, characterised in that

a) at least one monomer containing carboxyl group of the general formula (1)

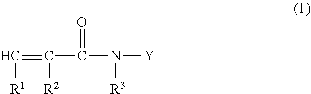

in which
R¹, R² and Y, independently of one another,
denote H or CH₃,
   R³ denotes R⁴—COOM and
   R⁴ denotes straight-chain or branched alkylene having 2 to 4 C atoms and
   M denotes H, Na, K or NH₄,
   and/or a monomer containing carboxyl group of the general formula (2)

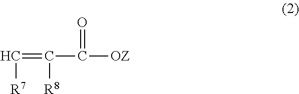

in which
R⁷ and R⁸, independently of one another,
denote H or CH₃, or
   R⁷ denotes COOM if Z=M and R⁸=H,
   Z denotes either M or R⁴—COOM where
   R⁴ denotes straight-chain or branched alkylene having 2 to 4 C atoms,
   and
   M denotes H, Na, K or NH₄,
   optionally together with a water-soluble monomer, is graft-polymerised onto a hydroxyl-containing inorganic, organic or hybrid support material, and
   b) some of the graft-polymerised carboxyl groups are subsequently converted into amide groups by coupling to an amine.

A selected variant of this process consists in that

a) at least one monomer containing carboxyl group of the general formula (1)

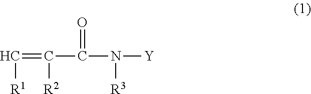

in which
R¹, R² and Y, independently of one another, denote H or CH₃,
R³ denotes R⁴—COOM,
R⁴ denotes straight-chain or branched alkylene having 2 to 4 C atoms and
M denotes H, Na, K or NH₄,
   and/or of the general formula (2)

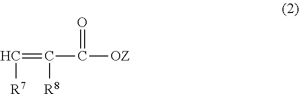

in which
R⁷ and R⁸, independently of one another, denote H or CH₃,
   or
R⁷ denotes COOM if Z=M and R⁸=H
Z denotes M or R⁴—COOM
R⁴ denotes straight-chain or branched alkylene having 2 to 4 C atoms,
   and
M denotes H, Na, K or NH₄,
   optionally together with a further water-soluble monomer, is dissolved in water so that the proportion of negatively charged groups is 1 to 100 mol % in relation to the total amount of monomer,
   b) the resultant solution is mixed with the support material in such a way that 0.05 to 100 mol of total monomer are employed per litre of sedimented support material,
   c) cerium(IV) salt dissolved in mineral acid is added to the resultant suspension, causing a pH in the range from 0-5 to arise, and a cerium(IV) concentration of 0.00001-0.5 mol/l, preferably 0.001-0.1 mol/l, and
   d) the reaction mixture is graft-polymerised within a time of 0.5 to 72 hours and
   e) an amine or an amine mixture is employed for the modification of the graft-polymerised carboxyl groups by coupling, and
   f) that the total amount of amine employed is in a molar ratio of 0.01 to 100:1 to the carboxyl groups bonded to the support and is converted into amide groups in the presence of a coupling reagent, which is employed in a molar ratio of 0.01:1 to 20:1 to the charged groups bonded to the support, and
   g) an alkyl-, aryl- or arylalkylamine having 6 to 18 C atoms from the group aniline, benzylamine, 4-fluorobenzylamine, 4-methoxybenzylamine, napthylmethylamine, phenacylamine, phenylethylamine, phenoxyethylamine, tryptamine or tyramine as free amine or as hydrochloride is employed for the coupling.

In order to carry out the process according to the invention, the dilute acid employed is an acid from the group sulfuric acid, hydrochloric acid and nitric acid, in a concentration in the range from 1 to 0.00001 mol/l, where the acid is mixed with a cosolvent in the volume ratio from 30:70 to 98:2. The cosolvent employed can be at least one solvent selected from the group dioxane, acetone, dimethylformamide, dimethylacetamide and tetrahydrofuran.

In order to obtain derivatised separating materials having the desired properties, the process is carried out using charged monomers and hydrophobic monomers in a ratio to one another such that the proportion of the hydrophobic component is 1-90 mol % in relation to the total amount of monomer, where 0.05-100 mol of monomers are employed per litre of sedimented support material.

A selected form of carrying out the process according to the invention consists in that functionalised (meth)acrylamides and (meth)acrylic acid are graft-polymerised onto the surface of a hydroxyl-containing inorganic, organic or hybrid support material in a one-step reaction.

Another variant of the process according to the invention consists in that a hydrophilic monomer is graft-polymerised on a hydroxyl-containing inorganic, organic or hybrid support material in a liquid reaction medium, and the resultant graft polymer is hydrophobically modified in a second step by a polymer-analogous reaction.

The process according to the invention for the preparation of the separating materials is preferably carried out by

a) dissolving a hydrophilic monomer in water, which is optionally mixed with further monomers in a ratio such that the proportion of negatively charged groups is 1 to 100 mol % in relation to the total amount of monomer,
b) mixing the resultant solution with the support material in such a way that 0.05 to 100 mol of total monomer are employed per litre of sedimented polymer material,
c) adding cerium(IV) salt dissolved in mineral acid to the resultant suspension, causing a pH in the range from 0-5 to arise, and
d) graft-polymerising the reaction mixture within a time of 0.5 to 72 hours.

The monomer unit used for the hydrophobic modification is preferably employed here in an excess of 100 to 10,000 mol % in relation to the charged groups bonded to the support in the presence of a coupling reagent, where the latter is employed in an excess of 60 to 2000 mol % in relation to the charged groups bonded to the support.

The present invention thus also relates to the separating material obtained in this way, which may be in the form of a chromatography column, and which has been derivatised in accordance with the invention by graft polymerisation.

The present invention likewise encompasses the use of the separating materials according to the invention for the removal of biopolymers from liquid media, in particular for the removal of protein from liquid media or for the removal of antibodies from liquid media. The removal is particularly selective if the biopolymer interacts with the ionic groups and optionally with the hydrophobic groups of the graft polymer covalently bonded to the surface of the support material. The biopolymer is adsorbed here by interacting both with the charged content of the graft polymer and also with the hydrophobic content. The subsequent liberation of the adsorbed biopolymer removed from the liquid can be carried out by desorbing the biopolymer bonded to the separating material by interaction with the ionic and optionally hydrophobic groups again either by

a) increasing the ion strength and/or
b) by modifying the pH
in the solution
and/or
c) by means of a suitable eluent having a different polarity to that of the adsorption buffer.

The invention described below accordingly relates to the preparation of graft copolymers on hydroxyl-containing surfaces of porous particles or of corresponding, suitable mouldings, which are characterised in that the graft polymers are built up from two or more recurring units, where at least one of the units carries a negative charge and at least one unit is linked to a hydrophobic group, and in that the graft polymers are able to bind charged substances, in particular charged substances which are found in cell cultures and cell culture supernatants, by ionic interaction.

The use of flexible graft polymers bonded to the support surface, so-called “tentacles”, as ion-exchanging groups is known. Thus, the graft polymer in the commercially available cation exchanger Fractogel® EMD SO₃⁻ (M) is built up from only one recurring unit containing sulfonic acid groups. The cation exchanger Fractogel® EMD COO⁻ (M) likewise consists only of recurring hydrophilic units. These cation exchangers exhibit only a low binding capacity, for example, for immunoglobulin (IgG) if the IgG is located in a solution having a conduction value greater than 10 mS/cm, i.e., for example, in a solution which comprises 150 mM sodium chloride.

The patents EP 0 337 144 or U.S. Pat. No. 5,453,186 give no information on monomer combinations which are preferred in the synthesis of a salt-tolerant ion exchanger. Only through our own attempts to prepare various graft polymers was it evident that the combination of hydrophobic and negatively charged monomers is particularly suitable for the planned use. Functionalised acrylamides and acrylic acid, as listed, for example, in Table 1, were preferably used for series of grafting experiments, since the polymers formed therefrom are hydrolysis-stable under alkaline conditions. For the investigations, the materials were subjected to treatment with 0.1 M to 1.0 M sodium hydroxide solution for a number of hours. More detailed investigations of the properties in aqueous solutions showed that the resultant, novel surface structures have very good swelling properties in spite of their hydrophobic properties.

This can apparently be attributed to the fact that the resultant poly(acrylamides), as known from the literature (W. Shi et al., J. Chromatography A, 2001, 924, 123-135), are able to form hydrogen bonds in aqueous solutions.

For the preparation of the separating materials according to the invention, a hydrophilic chromatography support, such as, for example, Fractogel TSK HW65 (S) or (M), which is identical to the commercially available Toyopearl HW-65 (S) and (M), can be used. This support is modified by means of graft copolymers. The graft copolymers bonded to the chromatography support are accessible by two different preparation routes:
a) The incorporation of all functional groups on the surface of the chromatography support is carried out by a single graft-polymerisation step in the one-step graft polymerisation or
b) in a two-step process, firstly grafting by suitable hydrophilic units is carried out, followed by incorporation of the hydrophobic groups by polymer-analogous reaction on the graft polymer.

For the preparation of the materials according to the invention, other chromatography supports can also be used. However, the prerequisite for this is that the material used contains reactive groups which are accessible to the graft-polymerisation reaction, in particular OH groups. Suitable support materials can therefore also be prepared, for example, from organic polymers. Organic polymers of this type can be polysaccharides, such as agarose, dextrans, starch, cellulose, etc., or synthetic polymers, such as poly(acrylamides), poly(methacrylamides), poly(acrylates), poly(methacrylates), hydrophilically substituted poly(alkyl allyl ethers), hydrophilically substituted poly-(alkyl vinyl ethers), poly(vinyl alcohols), poly(styrenes) and copolymers of the corresponding monomers. These organic polymers can preferably also be employed in the form of a crosslinked hydrophilic network. This also includes polymers made from styrene and divinylbenzene, which can preferably be employed, like other hydrophobic polymers, in a hydrophilised form. Alternatively, inorganic materials, such as silica, zirconium oxide, titanium dioxide, aluminium oxide, etc., can be employed as support. It is equally possible to employ composite materials, i.e., for example, separating materials according to the invention can be obtained by derivatisation of the surface, for example, of inorganic particles or mouldings, which are derivatised in the manner according to the invention. An example thereof are particles which can themselves be magnetised by copolymerisation of magnetisable particles or of a magnetisable core.

However, preference is given to the use of hydrophilic support materials which are stable to hydrolysis or can only be hydrolysed with difficulty since the materials according to the invention must withstand alkaline cleaning or regeneration at pH≧13 over an extended use duration. The supports may already carry low-molecular-weight ligands. Ligands may carry one or more charged groups, hydrophobic groups or groups which are able to form hydrogen bonds. Preference is given to ligands containing negatively charged groups.

The support materials may also consist of irregularly shaped or spherical particles, whose particle size can be between 2 and 1000 μm. Preference is given to particle sizes between 3 and 300 μm.

The support materials may, in particular, be in the form of non-porous or preferably porous particles. The pore sizes can be between 2 and 300 nm. Preference is given to pore sizes between 5 and 200 nm.

The support materials may equally also be in the form of membranes, fibres, hollow fibres, coatings or monolithic mouldings. Monolithic mouldings are three-dimensional bodies, for example in cylindrical form.

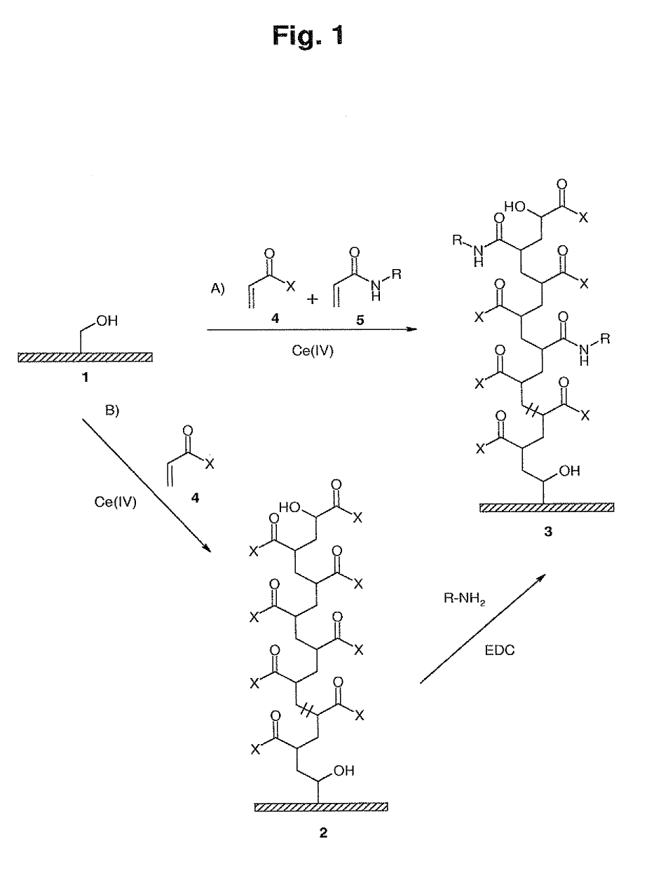

FIG. 1 shows diagrammatically the two preparation variants mentioned above. In detail, this figure shows the following:

Monomer 4, which contains an anionic group, and hydrophobic monomer 5 can be grafted as a mixture directly onto the hydrophilic support surface 1, giving the chemically modified surface 3 containing anionic and hydrophobic groups. If monomer 4 contains carboxyl groups, the hydrophilic anionic surface 2 can be produced first and subsequently converted into 3 by hydrophobic modification using, for example, an arylalkylamine and a carbodiimide as coupling reagent. Monomer 4 can be a mixture of hydrophilic monomers, and monomer 5 can be a mixture of hydrophobic and neutral monomers.

For the one-step graft polymerisation, at least one negatively charged monomer is used which contains, for example, sulfonic acid or carboxyl groups. Suitable monomers containing sulfonic acid groups are, for example, vinylsulfonic acid, styrenesulfonic acid, allylsulfonic acid, vinyltoluenesulfonic acid, acrylates of the formula 2 where Z=R⁴—SO₃M, in which R⁷ and R⁸ can have, independently of one another, the meanings hydrogen or alkyl having up to 6 C atoms, preferably hydrogen or methyl, carboxyl or carboxymethyl, and in which R⁴ can be a straight-chain alkylene group having 1 to 8 C atoms, such as, for example, methylene, ethylene, propylene or hexylene, or a branched alkylene group having 1 to 8 C atoms, such as, for example, isopropylenes or isobutylene. The alkylene group may optionally be mono- or polysubstituted by alkoxy or carboxyl groups. R⁴ can likewise have the meaning of an arylene group having up to 10 C atoms, such as, for example, phenylene. The alkylene group may optionally be mono- or polysubstituted, preferably mono- or disubstituted, in particular monosubstituted, by alkyl groups having 1 to 4 C atoms, alkoxy or carboxyl groups. R⁴ may also consist of a chain of an alkylene and an arylene group or an arylene and an alkylene group. M is a hydrogen atom or a metal cation, such as sodium or potassium, or an ammonium cations. M is selected so that the monomer is water-soluble. The sulfoalkyl acrylates, such as 3-sulfopropyl acrylate or 2-sulfoethyl acrylate, and the sulfoalkyl methacrylates, such as 3-sulfopropyl methacrylate or 2-sulfoethyl methacrylate, are mentioned by way of example. Preference is given to the use of the acrylamides of the formula 1 where R³=R⁴—SO₃M, in which R¹, R² and Y have, independently of one another, the meanings hydrogen or alkyl having up to 6 C atoms, preferably hydrogen or methyl, R¹ and R² may likewise be, independently of one another, carboxyl or carboxymethyl, R³ may also be R⁴—SO₃M, and in which R⁴ can be a straight-chain alkylene group having 1 to 8 C atoms, such as, for example, methylene, ethylene, propylene or hexylene, or a branched alkylene group having 1 to 8 C atoms, such as, for example, isopropylenes or isobutylene. The alkylene group may optionally be mono- or polysubstituted by alkoxy or carboxyl groups. R⁴ may likewise have the meaning of an arylene group having up to 10 C atoms, such as, for example, phenylene. The alkylene group may optionally be mono- or polysubstituted, preferably mono- or disubstituted, in particular monosubstituted, by alkyl groups having 1 to 4 C atoms, alkoxy or carboxyl groups. R⁴ may also consist of a chain of an alkylene and an arylene group or an arylene and an alkylene group. M is a hydrogen atom or a metal cation, such as sodium or potassium, or an ammonium cations. M is selected so that the monomer is water-soluble. Suitable acrylamides which may be mentioned here by way of example are 2-acrylamido-2-methylpropanesulfonic acid (AMPS) and 2-acrylamido-ethanesulfonic acid.

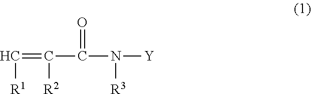

Suitable monomers containing carboxyl group can be, for example, cinnamic acid or acrylates of the formula 2 where Z=R⁵—COOM, in which R¹ and R² can have, independently of one another, the meanings hydrogen or alkyl having up to 6 C atoms, preferably hydrogen or methyl, carboxyl or carboxymethyl, and in which R⁵ can be a straight-chain alkylene group having 1 to 8 C atoms, such as, for example, methylene, ethylene, propylene or hexylene, or a branched alkylene group having 1 to 8 C atoms, such as, for example, isopropylenes or isobutylene. The alkylene group may optionally be mono- or polysubstituted by alkoxy or carboxyl groups. R⁵ may likewise have the meaning of an arylene group having up to 10 C atoms, such as, for example, phenylene. The alkylene group may optionally be mono- or polysubstituted, preferably mono- or disubstituted, in particular monosubstituted, by alkyl groups having 1 to 4 C atoms, alkoxy or carboxyl groups. R⁵ may also consist of a chain of an alkylene and an arylene group or an arylene and an alkylene group. M is a hydrogen atom or a metal cation, such as sodium or potassium, or an ammonium cations. M is selected so that the monomer is water-soluble. The carboxyalkyl acrylates, such as carboxyethyl acrylate, and the carboxyalkyl methacrylates are mentioned by way of example. Preference is given to the use of the acrylamides of the formula 1 where R³=R⁵—COOM, in which R¹, R² and Y have, independently of one another, the meanings hydrogen or alkyl having up to 6 C atoms, preferably hydrogen or methyl, R¹ and R² can likewise be, independently of one another, carboxyl or carboxymethyl, R³ can also be R⁵—COOM, and in which R⁵ can be a straight-chain alkylene group having 1 to 8 C atoms, such as, for example, methylene, ethylene, propylene or hexylene, or a branched alkylene group having 1 to 8 C atoms, such as, for example, isopropylenes or isobutylene. The alkylene group may optionally be mono- or polysubstituted by alkoxy or carboxyl groups. R⁵ may likewise have the meaning of an arylene group having up to 10 C atoms, such as, for example, phenylene. The alkylene group may optionally be mono- or polysubstituted, preferably mono- or disubstituted, in particular monosubstituted, by alkyl groups having 1 to 4 C atoms, phenyl, phenylmethyl, alkoxy or carboxyl groups. R⁵ may also consist of a chain of an alkylene and an arylene group or an arylene and an alkylene group. M is a hydrogen atom or a metal cation, such as sodium or potassium, or an ammonium cations. M is selected so that the monomer is water-soluble. An example of suitable acrylamides which may be mentioned here is acryloyl-gamma-aminobutyric acid. Particular preference is given to the use of unsaturated carboxylic acids of the formula 2 where Z=M, in which R⁷ and R⁸ can have, independently of one another, the meanings hydrogen or alkyl having up to 6 C atoms, preferably hydrogen or methyl, carboxyl or carboxymethyl. M is a hydrogen atom or a metal cation, such as sodium or potassium, or an ammonium cations. M is selected so that the monomer is water-soluble. Maleic acid, itaconic acid, citraconic acid, mesaconic acid, or fumaric acid may be mentioned by way of example. Of these, particular preference is given to monomers of the formula 2 where Z=M, in which R⁷ denotes hydrogen and R⁸ denotes hydrogen or alkyl having up to 3 C atoms. Acrylic acid (AA), methacrylic acid or ethacrylic acid may be mentioned by way of example for this purpose.

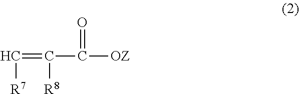

At least one hydrophobic monomer which has a pronounced hydrophobic content in the molecule is required as further component for the one-step graft polymerisation. Suitable hydrophobic monomers therefore contain at least one alkyl or aryl group or another group by means of which the hydrophobic properties of the molecule are caused. Preference is given to monomers whose hydrophobic properties are caused by alkyl groups having a suitable number of carbon atoms or by aryl groups. The hydrophobic monomers employed are preferably monomers which contain alkyl or aryl groups. Hydrophobic monomers which are suitable for the use according to the invention are, for example, acrylates of the formula (2), in which R⁷ has the meaning hydrogen, R⁸ denotes hydrogen or methyl and Z denotes straight-chain or branched alkyl having 4 to 18 C atoms, aryl, R⁶-aryl or R⁴—CONHX, where X denotes straight-chain or branched alkyl having 6 to 8 C atoms, aryl, R⁶-aryl, and R⁶ denoted a straight-chain or branched alkylene having 1 to 4 C atoms, butyl acrylate and butyl methacrylate may be mentioned by way of example. Preference is given to the acrylamides of the general formula 1, in which R¹ and R² have, independently of one another, the meanings hydrogen or alkyl having up to 6 C atoms, preferably hydrogen or methyl, and in which Y and/or R³ have, independently of one another, the meaning alkyl, where Y and R³ together carry at least 6 C atoms, preferably 6 to 18 C atoms, and methylene groups may be replaced by O, aryl, alkylaryl, arylalkyl, where alkyl and/or aryl group may be mono- or polysubstituted, preferably mono- or disubstituted, in particular monosubstituted, by alkoxy, cyano, carboxyl, acetoxy or acetamino radical, and. Y and/or R³ accordingly preferably denote, independently of one another, methyl, ethyl, propyl, butyl, pentyl, hexyl, heptyl, octyl, nonyl, decyl, 2-, 3-, or 4-oxapentyl, 2-, 3-, 4- or 5-oxahexyl, 2-, 3-, 4-, 5- or 6-oxaheptyl, 3-butoxypropyl, isopropyl, 3-butyl, isobutyl, 2-methylbutyl, isopentyl, 2-methylpentyl, 3-methylpentyl, 2-oxa-3-methylbutyl, 2-methyl-3-oxahexyl. Y and/or R³ can preferably also have, independently of one another, the meaning of a phenyl group, which is preferably monosubstituted by cyano, cyanoalkyl, alkyl, alkoxy, alkoxyalkyl, preferably in the p-position. Y and/or R³ preferably stand, independently of one another, for a phenyloxyalkyl group, such as phenoxyethyl, or a phenylalkyl group, in particular Y and/or R³ particularly preferably stand, independently of one another, for benzyl, phenylethyl, phenylpropyl. Alkyl groups can carry oxo groups. The hydrophobic monomers in this case are particularly preferably acrylamides of the formula 1, in which R¹ and R² have, independently of one another, the meanings hydrogen or alkyl having up to 6 C atoms, preferably hydrogen or methyl, in which Y has the meaning hydrogen and in which R³ has the meanings alkyl, where R³ carries at least 6 C atoms, preferably 6 to 18 C atoms, and methylene groups may be replaced by 0, aryl, alkylaryl, arylalkyl, where alkyl and/or aryl group may be mono- or polysubstituted, preferably mono- or disubstituted, in particular monosubstituted, by alkoxy, cyano, carboxyl, acetoxy or acetamino radical. R³ accordingly preferably denotes hexyl, heptyl, octyl, nonyl, decyl, 2-, 3-, 4-, 5- or 6-oxaheptyl, 3-butoxypropyl, 2-methyl-3-oxahexyl. R³ can preferably also have the meaning of a phenyl group, which is preferably monosubstituted by cyano, alkyl, alkoxy, alkoxyalkyl, preferably in the p-position. R³ preferably stands for a phenyloxyalkyl group, such as phenoxyethyl, or a phenylalkyl group, in particular R³ particularly preferably stands for benzyl, phenylethyl, phenylpropyl. Alkyl groups can carry oxo groups, as in 2-phenyl-2-oxoethyl. The monomers acryloylglycinalanine, acryloylphenylalanine, benzylacrylamide, octylacrylamide may be mentioned here by way of example.

Furthermore, neutral monomers, which are preferably hydrophilic, can optionally be added in the one-step graft polymerisation. In this way, it is possible to improve the swelling behaviour of the graft polymers in aqueous media without increasing the charge density of the graft polymers. Neutral monomers which are suitable for this purpose are, for example, lower alkyl acrylates, such as methyl acrylate, lower alkyl methacrylates, such as methyl methacrylate. Preference is given to the use of acrylamides of the general formula 1 where Y=R⁶, in which R¹ and R² are, independently of one another, hydrogen or methyl and in which R³ and R⁶ denote, independently of one another, hydrogen or alkyl having up to 4 C atoms. R³ and/or R⁶ thus denote hydrogen or lower alkyl. The latter preferably has the meaning methyl, ethyl, butyl, isopropyl, 3-butyl or isobutyl here and in addition the meaning of alkoxyalkyl having up to 4 C atoms, such as, for example, methoxyethyl or ethoxyethyl. Acrylamide (AAm), dimethylacrylamide, methacrylamide, isopropylacrylamide, methoxyethylacrylamide and ethoxyethylacrylamide may be mentioned here by way of example.

The actual graft polymerisation reaction can be initiated by cerium(IV) on the hydroxyl-containing support. This reaction is normally carried out in dilute mineral acids, such as, for example, in dilute nitric acid, in which the hydrophobic monomers are sparingly soluble or insoluble. The reaction can also be carried out in dilute sulfuric acid or hydrochloric acid. However, it is preferably carried out in dilute nitric acid. The addition of a solubiliser or cosolvent, preferably dioxane, enables the hydrophobic monomer to be dissolved and grafted. Cosolvents which can be employed are also acetone, dimethylacetamide, dimethylformamide, tetrahydrofuran. However, dioxane is particularly preferably used since it provides the highest graft yield and the least by-products in the cerium(IV)-initiated reaction. It should additionally be noted here that other processes for graft polymerisation can also be used. Preference is given to methods in which only few by-products, such as noncovalently bonded polymer, which have to be removed, are formed. Processes with controlled free-radical polymerisation, such as, for example, the method of atom transfer radical polymerisation (ATRP), appear particularly interesting. In a first step here, an initiator group is covalently bonded to the support surface in the desired density. An initiator group can be, for example, a halide bonded via an ester function, as in a 2-bromo-2-methylpropionic acid ester. The graft polymerisation is carried out in the presence of copper(I) salts in a second step.

If the hydrophobic monomer has not dissolved completely in the liquid phase, which is evident, for example, from clouding of the reaction solution or from droplets of a second liquid phase, grafting does take place through the reaction of the two monomers, but the resultant product behaves rather more like a normal ion exchanger. The properties in this case are thus determined principally by the charged monomer unit. This means that the graft copolymer must be prepared in such a way that charged and hydrophobic functions in the graft polymer can cooperate with one another in solution. For the reaction, it is therefore attempted to employ the dilute acid and the cosolvent in a ratio which is the most favourable for the specific reaction. For carrying out the graft polymerisation, the acid is usually employed in an aqueous solution having a concentration in the range from 1 to 0.00001 mol/l, preferably 0.1 to 0.001. Dilute nitric acid, which is employed with a concentration in the range from 0.05 to 0.005 mol/l, is very particularly preferably used. In order to carry out the reaction, the volume ratio of dilute acid to suitable cosolvent can be in the range from 30:70 to 98:2. A volume ratio of 40:60 to 90:10 is preferably used. Particularly good binding capacities are found if the dilute acid used and the cosolvent are in a volume ratio in a range from 45:55 to 75:25. This applies, in particular, if a monomer containing sulfonic acid groups is used in dilute nitric acid and dioxane as cosolvent.

If, by contrast, too much cosolvent is added, the yield of graft polymer drops. Consequently, too little protein can be bound to the derivatised separating material obtained. The yield of graft polymer on the support material can be increased by adding further solution of a hydrophobic monomer in the presence of a cosolvent to a graft polymerisation with charged monomer which has already started.

Further series of experiments have shown that separating materials derivatised by graft polymerisation and having properties improved in accordance with the invention are obtained if suitable support materials are graft-polymerised with the monomers mentioned in the following table.

TABLE 1
Monomers for graft copolymerisation.

| Monomer name | Abbreviation | Structure |
|---|---|---|
| 2-Acrylamido-2- methyl- propanesulfonic acid | AMPS | 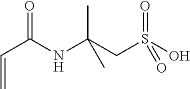 |
| Acrylic acid | AA | 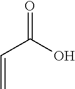 |
| N-Arylalkylacryl- amides (for example benzylacryl- amide, acryloylphenyl- alanine) | ArAAm | 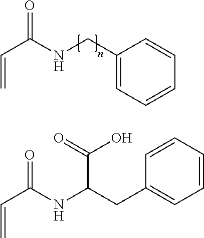 |
| N-Carboxyalkylacryl- amides (for example acryloyl-gamma- amino-butyric acid) | CAAAm | 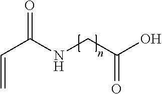 |
| N-Alkylacrylamides (for example butyl- acrylamide) | AlkylAAm | 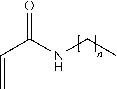 |

The following support-bound graft copolymers on suitable supports, such as, for example, Fractogel TSK HW65 (M), which is identical to the commercially available Toyopearl HW-65 (M) (manufacturer: Tosoh, Japan, and as described in EP 0 006 199), were prepared by way of example by combination of two or three monomers and investigated with respect to their properties, in particular their binding capacity:

Poly(AMPS, AA, ArAAm) with benzylacrylamide
Poly(AMPS, ArAAm) with benzylacrylamide
Poly(AA, ArAAm) with benzylacrylamide, acryloylphenylalanine
Poly(AMPS, ArAAm, AAm) with benzylacrylamide
Poly(AA, ArAAm, AAm) with benzylacrylamide
Poly(CAAAm, ArAAm) with carboxypropylacrylamide and benzylacrylamide
Poly(AMPS, AlkylAAm) with butylacrylamide

It has been found that although lower alkylacrylamides (AlkyAAm), such as butylacrylamide, can be copolymerised with monomers which contain sulfonic acid groups, such as, for example, AMPS, the derivatised support materials only exhibit, however, binding capacities for immunoglobulin (IgG) in the region of known separating materials, such as, for example, that of the graft polymer made from pure AMPS.

In this connection, it has been found that the higher alkyl groups, such as, for example, octyl groups, make a positive contribution to the binding of proteins. Surprisingly, however, it has proven particularly advantageous in the course of the investigations to admix aromatic monomers (for example ArAAm) with the reaction mixture during the preparation of salt-tolerant ion exchangers. These monomers enable hydrophobic groups to be incorporated into the ionic surface modification. Depending on the amount of aromatic monomers added, the hydrophobic character of the resultant materials is increased and the binding capacity thus influenced so that the binding capacity can be influenced per se depending on the mole fraction of hydrophobic groups in the graft polymer. It has also been found that the ratio of the monomers to one another must be selected differently, depending on the combination of the selected monomers and on the polymerisation conditions, in order to achieve high binding capacities.

If the poly(acrylamide) graft polymers contain only sulfonic acid groups as charged groups, particularly advantageous properties are found if the proportion of charged groups is 35 to 70 mol % in relation to the total amount of graft polymer. A separating material containing 100 mol % of charged groups corresponds to a pure cation exchanger without hydrophobic groups.

A different situation arises if the graft polymer contains carboxyl groups in addition to other charged groups, such as, for example, in a copolymer with acrylic acid, or only charged groups of this type are present. In such cases, improved binding capacities are found if the proportion of charged groups is 60 to 98 mol %, based on the total amount of graft polymer. Particularly advantageous properties have been found for materials in which the proportion of charged groups is in the range from 70 to 95 mol %.

In order to obtain graft polymers having advantageous properties, charged monomers and hydrophobic monomers are mixed in a ratio to one another such that the proportion of the hydrophobic component is 1-90 mol % in relation to the total amount of monomer, preference is given to a proportion in the range from 3-70 mol %, based on the total amount of monomer. On use of AMPS, the proportion of the hydrophobic component is selected, in particular, so that it is in a range from 20-60 mol %, based on the total amount of monomer. On use of AA, particularly good properties of the graft polymers are achieved if the proportion of the hydrophobic component is in the range from 5-50 mol %. For the preparation of the separating materials according to the invention, the monomers are normally added to the support material in excess. 0.05 to 100 mol of total monomer are employed per litre of sedimented polymer material, preferably 0.15-25 mol/l are employed.

Sedimented support material is taken to mean moist support material obtained by sedimentation from a suspension which has been freed from supernatant solvent. Corresponding support material is usually stored in the moist state. For the use according to the invention, supernatant solvent is removed in advance by suction. In order to carry out the derivatisation, a measured volume or a weighed amount (filter-moist gel) is subsequently suspended in a suitable volume or a suitable amount of monomer solution and subjected to the graft polymerisation. The support material can be a hydroxyl-containing inorganic, organic or hybrid support material. It can thus also be an organic polymer material.

Although the second preparation variant has, as a two-step process, the disadvantage of an additional reaction step, the graft polymerisation is, however, not restricted by the efficacy of the added cosolvent. In a first graft-polymerisation step, it is preferred to graft only hydrophilic monomers, which are readily soluble in the liquid reaction medium. At least one monomer here contains carboxyl groups. The graft polymer can then be hydrophobically modified in a second step by a polymer-analogous reaction. This step can be carried out, for example, by coupling of benzylamine with water-soluble carbodiimide to a poly(acrylic acid) graft polymer, giving a grafted poly(benzylacrylamide).

Monomers which can be employed for the two-step process are the monomers already mentioned for the one-step graft polymerisation. The monomers containing carboxyl group can be employed in a graft polymerisation alone or also as a mixture with hydrophobic, neutral monomers and/or with monomers containing sulfonic acid groups. Preference is given to the use of mixtures with neutral monomers and/or with monomers containing sulfonic acid groups. Particular preference is given to water-soluble monomers containing carboxyl group or mixtures of water-soluble monomers containing carboxyl group with further water-soluble monomers. The following water-soluble monomer containing carboxyl group of the general formula (1) are thus particularly preferred

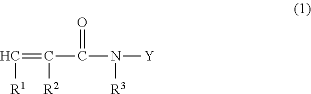

in which R¹, R² and Y denote, independently of one another, H or CH₃, R³ has the meaning R⁴—COOM, where R⁴ denotes straight-chain or branched alkylene having 2 to 4 C atoms, and M denote H, Na, K or NH₄, or of the general formula (2)

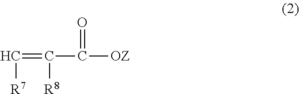

in which R⁷ and R⁸ denote, independently of one another, H or CH₃, Z denotes either M or R⁴—COOM, where R⁴ denotes straight-chain or branched alkylene having 2 to 4 C atoms, R⁷ can also denote COOM if Z is M and R⁸ is H, and M denotes H, Na, K or NH₄. Further water-soluble monomers can be the corresponding sulfonic acids of the water-soluble monomer containing carboxyl group, where the group R⁴—COOM has been replaced by R⁴—SO₃M, or the neutral monomers already mentioned for the one-step graft polymerisation. Example of water-soluble monomer are containing carboxyl group are acrylic acid, carboxyethylacrylamide, carboxyethyl acrylate, carboxyethylmethacrylamide, carboxymethylacrylamide, carboxymethyl acrylate, carboxymethylmethacrylamide, carboxypropylacrylamide and carboxypropylmethacrylamide, methacrylic acid and maleic acid. Examples of further water-soluble monomers are acrylamide, 2-acrylamidoethanesulfonic acid, AMPS, isopropylacrylamide, methyl acrylate, methyl methacrylate, 2-sulfoethyl acrylate, 2-sulfoethyl methacrylate, 3-sulfopropyl acrylate, 3-sulfopropyl methacrylate.

In the coupling reaction of benzylamine to, for example, poly(acryloyl-gamma-aminobutyric acid) graft polymers, it is possible to react virtually all carboxyl groups if the benzylamine is employed in an excess of about 4000 mol % in relation to the carboxyl groups bonded to the support. With an excess of coupling reagent EDC (N-(3-dimethylaminopropyl)-N′-ethylcarbodiimide hydrochloride) of 300 mol % in relation to the carboxyl groups bonded to the support, a conversion of about 90% of the carboxyl groups present into amide groups is achieved. However, the aim of the reaction according to the invention is to react only some of the carboxyl groups in order that sufficient ion-exchanging groups remain present in the graft polymer. If, in the above example, only 60 mol % of EDC are employed, only about 30% of the carboxyl groups are reacted, and the binding capacity of the product in the presence of salt is twice as high as in the above case.

The excess of monomer to be coupled is selected depending on how high the desired proportion of reacted carboxyl groups is intended to be. Thus, the excess of monomer to be coupled can be in the range from 100 to 10,000 mol % in relation to the carboxyl groups bonded to the support, while the coupling reagent is employed with an excess in the range from 60 to 2000 mol % in relation to the carboxyl groups bonded to the support. The ratio both of the monomer to be coupled and also of the coupling reagent is of course selected so that sufficient carboxyl groups can be reacted and it is possible to prepare a separating material which has advantageous or improved properties after performance of the second reaction step and is suitable for the removal of the target molecules, such as, for example, charged biopolymers, from liquids, such as, for example, cell culture supernatants.

At high surface densities, for example, of poly(acrylic acid), about 30% of the carboxyl groups present were reacted under the selected conditions in the case of an excess of amine and a deficiency of EDC in relation to the carboxyl groups bonded to the support. However, a large excess of coupling reagent also enables a higher proportion of the carboxyl groups to be reacted. However, a disadvantage of this procedure in the case of reactions on an industrial scale is a considerable increase in the costs of the two-step preparation. For economic reasons, this procedure is therefore not a true alternative.

Significantly more favourable is the preparation of a graft copolymer from a mixture of monomers containing carboxyl or sulfonic acid groups. A mixture of AMPS and AA as precursor may be mentioned here by way of example since, due to the sulfonic acid groups, ion-exchanging groups are still present in the graft polymer even in the case of optionally complete conversion of the carboxyl groups. Complete conversion can be achieved, in particular at low graft polymer densities, as already described above, by an excess of the coupling reagent EDC of at least 300 mol % in relation to the carboxyl groups bonded to the support. However, the carboxyl groups generally cannot always be reacted completely here at high graft polymer densities. Thus, it has been found that coupling of benzylamine to a graft polymer consisting of about 30 mol % of AMPS units and 70 mol % of acrylic acid units gives a graft polymer which, besides about 20 mol % of benzylacrylamide units, still contains 50 mol % of acrylic acid units. It thus consists of three monomer units, although, in accordance with the original synthesis plan, in which complete conversion was expected through the use of 100-150 mol % of EDC, only two units should have been present.

For a polymer-analogous reaction on the graft polymer consisting of AMPS and AA, 3 mol of benzylamine were employed, for example, per litre of sedimented polymer material. 0.2 mol/l of EDC were added as coupling reagent, which corresponds approximately to 100 mol % in relation to the carboxyl groups bonded to the support.

In order to obtain suitable graft polymers containing carboxyl groups for the hydrophobic modification, at least one monomer containing carboxyl groups is generally dissolved in water and mixed with further monomers possibly present in such a way that the proportion of the component containing carboxyl groups is 1-100 mol % in relation to the total amount of monomer, preferably 10-100 mol %. The monomers are normally added to the support material in excess. 0.05 to 100 mol of total monomer are employed per litre of sedimented polymer material, preference is given to the use of 0.15-25 mol/l. A solution of the cerium(IV) salt in mineral acid, preferably ammonium cerium(IV) nitrate in nitric acid, ideally likewise freed from oxygen, is added to the aqueous suspension, freed from oxygen, with stirring at a temperature of 5-95° C., preferably 20-70° C., and subsequently stirred at this temperature for the duration of 0.5 to 72 hours, preferably 2 to 20 hours. The concentrations in the aqueous solution which arise after addition of the cerium(IV) salt solution are selected so that the pH is 0-5, preferably 1-3. The cerium(IV) concentration is set so that it is 0.00001-0.5 mol/l, preferably 0.001-0.1 mol/l, in the reaction solution.

Table 2 gives examples of primary amines which have been coupled to support-bound graft copolymers of AMPS and AA (on Fractogel® TSK HW65 M). In addition, it is also possible to couple a plurality of amines to the support material or to use mixtures of amines for the coupling reaction. Corresponding examples are also shown in Table 3. In addition, all amines which result in the acrylamides already mentioned as hydrophobic monomer units in the case of the one-step graft polymerisation can be employed. It is known to the person skilled in the art that an alternative coupling method, for example via the hydroxysuccinimide esters, prepared using EDC, of the graft polymers, must be selected in the case of coupling of amine units to carboxyl groups.

In addition, it has been found that, as in the case of graft copolymers containing aromatic groups, which can in some cases already be prepared by one-step synthesis, alkyl groups, such as, for example, octyl groups, in a graft polymer together with sulfonic acid and carboxyl groups also result in an improvement in the binding properties compared with non-hydrophobically modified cation exchangers.

Thus, graft polymers having different hydrophobic contents, but the same graft densities, can be prepared by the two-step synthesis in a simple manner, starting from, for example, a poly(acrylic acid) precursor. In Table 3, the results of the examples shown in lines 6-8 show such a series with different proportions in mol % of benzyl groups in the graft polymer. Experiments have also shown that there is a binding optimum at about 25 mol % of benzyl groups in the graft polymer. The recovery of a polyclonal IgG is higher the fewer benzyl groups are present in the graft polymer. Experiments with monoclonal antibodies have shown that the recovery is also approximately 100% in the case of about 25 mol % of benzyl groups in the graft polymer. The elution in the case of monoclonal proteins can be optimised more easily since, in contrast to polyclonal proteins, very similar species have to be dissolved off.

In order to assess the separating materials, the static binding capacity of polyclonal human IgG (Gammanorm) in 75 mM and 150 mM sodium chloride solution is generally investigated in the range pH 5-7. The conduction value of the 150 mM salt concentration corresponds to that of a cell culture supernatant (frequently 10-15 mS/cm). The binding capacity is determined after elution of the IgG by increasing the salt concentration to about 1 M NaCl.

The dynamic binding capacity is likewise determined in the presence of 150 mM sodium chloride. To this end, charging with IgG solution is carried out to a breakthrough of 10%. The elution is carried out by increasing the salt concentration to about 1 M NaCl at the pH of the binding buffer. An improvement in the recovery of IgG can be achieved by simultaneously increasing the salt concentration and the pH.

The examples in Table 3 show that the separating materials with graft copolymers achieve significantly higher dynamic binding capacities than the comparative gels which have no hydrophobic moieties in the graft polymer. High binding capacities are achieved by the graft copolymers at pH 5.5. At this pH, the graft copolymer is negatively charged. By contrast, the IgG carries more positive than negative charges (pH<pI). The binding thus takes place principally through ionic interactions. If the positive charges on a polyclonal IgG are reduced by re-buffering to pH 6.5 and its pI is approached, the breakthrough value of 10% is already achieved with very small amounts of IgG. This binding behaviour is exhibited by all graft copolymers, irrespective of whether their synthesis is carried out directly only by a graft polymerisation step or by hydrophobic modification of a suitable hydrophilic graft polymer.

In summary, it can be stated that particularly suitable separating materials for ion exchange chromatography at a conduction value as is usually present in cell culture supernatants contain a graft copolymer which consists at least of a monomer unit which carries a negative charge in the form of a sulfonic acid or carboxylic acid and in addition contains ester or amide groups and alkyl and/or alkylene groups and in total a maximum of 8 C atoms, but no aryl groups, or which carries a negative charge in the form of a sulfonic acid or carboxylic acid and in addition contains alkyl and/or alkylene groups, but no aryl groups, and comprises at least one monomer unit which carries an ester group and, as hydrophobic group, a straight-chain or branched alkyl having 4 to 18 C atoms or an aryl group and which contains at least one amide group and, as hydrophobic groups, straight-chain or branched alkyls having a total of 6 to 18 C atoms or an aryl group. The ratio of the monomer units having a negative charge to the monomer units containing a hydrophobic group is preferably in a range between 99:1 to 10:90.

The hydrophobic moieties in the graft polymers enable binding to take place at higher salt concentration, since the charges in the pure cation exchangers are masked by the salt ions present, so that the ionic interaction is too weak to bind proteins to the separating materials. The additional hydrophobic-hydrophobic interaction with the proteins enables sufficiently strong binding.

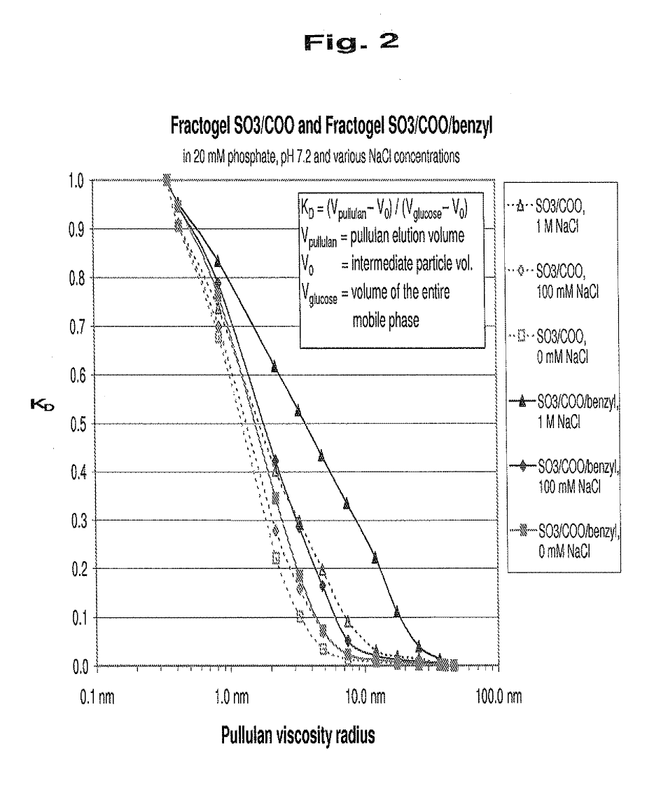

This hydrophobic interaction probably also occurs within or between graft polymer chains and results in reversible linking of these chains (C. Tribet, Biochimie, 1998, 80, 461-473). For characterisation, a hydrophobically modified graft copolymer prepared in a two-step synthesis on a porous support and its poly(AMPS, AA) precursor bound to Fractogel® TSK HW65 M was therefore analysed by inverse size exclusion chromatography (FIG. 2). Although the two gels have the same graft density, it was found that the pore system of the hydrophobic graft copolymer is more accessible under non-binding conditions, in particular in the presence of 1 M sodium chloride. The more hydrophobic graft polymer thus lies more compactly on the surface of the porous support under high-salt conditions. Nevertheless, the pore system with the more hydrophobic graft polymer also exhibits smaller distribution coefficients KD with decreasing sodium chloride concentration. This surface structure is thus greatly swollen at sodium chloride concentrations less than 1 M and very readily accessible to the components dissolved in the aqueous buffer.

The materials according to the invention can be used for the separation of charged biopolymers. They are preferably employed for the separation of proteins, in particular antibodies, which may be polyclonal or monoclonal, from antibody fragments or fusion proteins which contain an antibody part. However, other biopolymers can also be separated off, such as, for example, polypeptides, nucleic acids, viruses, eukaryotic or prokaryotic cells. The separation enables the biopolymers to be purified, isolated or removed.

The target molecules are separated from at least one or more other substances from a sample, where the sample which comprises the target molecule is dissolved in a liquid, which is brought into contact with the material according to the invention. Contact times are usually in the range from 30 seconds to 24 hours. It is advantageous to work in accordance with the principles of liquid chromatography by passing the liquid through a chromatography column which contains the separating material according to the invention. The liquid can run through the column merely through its gravitational force or be pumped through by means of a pump. An alternative method is batch chromatography, in which the separating material is mixed with the liquid by stirring or shaking for as long as the target molecules or biopolymers need to be able to bind to the separating material. It is likewise possible to work in accordance with the principles of the chromatographic fluidised bed by introducing the liquid to be separated into, for example, a suspension comprising the separating material, where the separating material is selected so that it is suitable for the desired separation owing to its high density and/or a magnetic core.

The target molecule usually binds to the material according to the invention. The separating material can subsequently be washed with a wash buffer, which preferably has the same ion strength and the same pH as the liquid in which the target molecule is brought into contact with the separating material. The wash buffer removes all substances which do not bind to the separating material. Further washing steps with suitable buffers may follow. The desorption of the bound target molecule is carried out by increasing the ion strength in the eluent. By changing the pH in the eluent, preferably by increasing the pH, through the use of an eluent having a different polarity to that of the adsorption buffer or, if desired, through the use of a surfactant dissolved in the eluent, elution is likewise possible, preferably in combination with an increase in the ion strength. The target molecule can thus be obtained in a purified and concentrated form in the eluent. The target molecule usually has a purity of 70% to 99%, preferably 85% to 99%, particularly preferably 90%-99%, after desorption.

However, it is also possible for the target molecule to remain in the liquid, but for other accompanying substances to bind to the separating material. The target molecule is then obtained directly by collecting the column eluate in through-flow. It is known to the person skilled in the art how he has to adapt the conditions, in particular the pH and/or the conductivity, in order to bind a specific biopolymer to a separating material, or whether it is advantageous for the purification task not to bind the target molecule.

The biopolymers predominantly, but not exclusively, originate from liquid sources or are present therein, such as, for example, in body fluids, such as blood, sera, saliva or urine, organ extracts, milk, whey, plant extracts, cell extracts, cell cultures, fermentation broths, animal extracts. Antibodies may originate, for example, from mammal cells from rodents or hybridoma cells.

The separating material according to the invention can be used in a first chromatographic purification step (capture step) of a work-up process for a biopolymer. It is normally advantageous for the solid-containing crude solutions, such as, for example, cell suspensions or cell homogenates, firstly to be filtered before the capture step in order to remove coarse impurities, such as entire cells or cell debris. An advantage of the present invention, as described above, consists in that the ion strength of the cell culture supernatant does not have to be adapted. The capture step is generally followed, if the desired purity of the biopolymer has not yet been achieved, by further chromatographic purification steps using other separating materials which are capable of removing the various residual impurities. Since the sequence in which the separating materials are used may have an influence on the overall performance of the process, it may in certain cases be advantageous not to employ the separating material according to the invention until the second, third or fourth purification step.

The invention likewise relates to a kit for the purification or separation of biopolymers from one or more other substances in a liquid. The kit consists of a chromatography column which is packed with the separating material according to the invention, one or more buffers and a pack leaflet with written instructions. The liquid is adjusted to a pH of, for example, 5.5 using a buffer and brought into contact with the chromatography column. The column is firstly washed with a wash buffer, giving one fraction of the non-binding constituents, and the biopolymers are then desorbed using an elution buffer of higher ion strength, for example using 1 M NaCl solution, and obtained in a second fraction.

The present description enables the person skilled in the art to apply the invention comprehensively. Even without further comments, it is therefore assumed that a person skilled in the art will be able to utilise the above description in the broadest scope.

If anything is unclear, it goes without saying that the publications and patent literature cited should be consulted. Accordingly, these documents are regarded as part of the disclosure content of the present description.

For better understanding and in order to illustrate the invention, examples are given below which are within the scope of protection of the present invention. These examples also serve to illustrate possible variants. Owing to the general validity of the inventive principle described, however, the examples are not suitable for reducing the scope of protection of the present application to these alone.

Furthermore, it goes without saying to the person skilled in the art that, both in the examples given and also in the remainder of the description, the component amounts present in the compositions always only add up to 100% by weight or mol %, based on the composition as a whole, and cannot exceed this, even if higher values could arise from the per cent ranges indicated. Unless indicated otherwise, % data are % by weight or mol %, with the exception of ratios, which are shown in volume data, such as, for example, eluents, for the preparation of which solvents in certain volume ratios are used in a mixture.

The temperatures given in the examples and the description as well as in the claims are always in ° C.

### EXAMPLES

### Example 1

### Procedure for the Preparation of a Graft Copolymer from 2-Acrylamido-2-Methylpropanesulfonic Acid and Benzylacrylamide (Batch 05SW136)

### Procedure:

A suspension of 70 g of filter-moist Fractogel TSK HW65 (M) (washed with dilute mineral acid and deionised water), a solution of 32.3 g of benzylacrylamide in 250 ml of dioxane and a solution of 41.5 g of 2-acrylamido-2-methylpropanesulfonic acid and 25 g of 32% sodium hydroxide solution in 50 ml of deionised water is prepared in a glass reaction apparatus with a paddle stirrer. The suspension is made up to 475 ml with deionised water and adjusted to pH 4 using 32% sodium hydroxide solution or 65% nitric acid.

A starter solution comprising 13.7 g of ammonium cerium(IV) nitrate and 1.2 g of 65% nitric acid in 25 ml of deionised water is initially introduced in a dropping funnel with pressure equalisation. The entire apparatus is rendered inert by repeated (3×) evacuation and decompression with nitrogen. The suspension in the apparatus is subsequently warmed to 70° C.

The starter solution is added to the inertised suspension with stirring at an internal temperature of 70° C. The suspension is stirred at 70° C. for 17 hours under a gentle stream of nitrogen. The reaction solution is then filtered through a glass filter frit (P2) with suction, and the gel on the frit is washed with in each case 100 ml of washing solution as follows:

8×0.5 M sulfuric acid, 0.2M ascorbic acid
3× deionised water
2×1 M sodium hydroxide solution
4× deionised water
5× acetone
5× water

The gel is suspended in 200 ml of deionised water and adjusted to pH 7 using 25% hydrochloric acid. The gel is stored in 20% ethanol at room temperature.

### Example 2

### Procedure for the Preparation of a Graft Copolymer from Acrylic Acid and Benzylacrylamide (Batch 06SW297)

### Procedure:

A suspension of 77.9 g of filter-moist Fractogel TSK HW65 (M) (washed with dilute mineral acid and deionised water), a solution of 1.34 g of benzylacrylamide in 14.5 ml of dioxane and a solution of 18.0 g of acrylic acid in 50 ml of deionised water is prepared in a glass reaction apparatus with a paddle stirrer. The suspension is adjusted to pH 4 using 32% sodium hydroxide solution and made up to 375 ml with deionised water.

A further 6.72 g of benzylacrylamide are dissolved in 73 ml of dioxane in a dropping funnel with pressure equalisation and made up to 100 ml with deionised water.

A starter solution comprising 9.6 g of ammonium cerium(IV) nitrate and 1.2 g of 65% nitric acid in 25 ml of deionised water is initially introduced in a second dropping funnel with pressure equalisation. The entire apparatus is rendered inert by repeated (3×) evacuation and decompression with nitrogen.

The suspension in the apparatus is subsequently warmed to 55° C.

The starter solution is added to the inertised suspension with stirring at an internal temperature of 55° C. The suspension is stirred at 55° C. under a gentle stream of nitrogen, and 20 ml of the benzylacrylamide/dioxane solution are added every 30 min. In total, the reaction suspension is stirred at 55° C. for a further 17 hours after addition of the starter. The reaction solution is then filtered through a glass filter frit (P2) with suction, and the gel on the frit is washed with in each case 100 ml of washing solution as follows:

2×0.5 M sulfuric acid/0.2 M ascorbic acid-acetone 1:1 (V/V)
8×0.5M sulfuric acid, 0.2M ascorbic acid
3× deionised water
2×1 M sodium hydroxide solution

The gel is suspended in 200 ml of 1 M sodium hydroxide solution and shaken for 20 hours, after suction filtration on the frit the gel is washed further with in each case 100 ml of washing solution as follows:

2×1 M sodium hydroxide solution
5× deionised water

The gel is suspended in 200 ml of deionised water and adjusted to pH 7 using 25% hydrochloric acid. The gel is stored in 20% ethanol at room temperature.

### Example 3

### Procedure for the Preparation of a Graft Copolymer from 2-Acrylamido-2-Methylpropanesulfonic Acid, Acrylic Acid and Benzylacrylamide (Batch 06SW085)

### Procedure:

A suspension of 69 g of filter-moist Fractogel TSK HW65 (M) (washed with dilute mineral acid and deionised water), a solution of 32.2 g of benzylacrylamide in 250 ml of dioxane, a solution of 25.9 g of 2-acrylamido-2-methylpropanesulfonic acid and 15.6 g of 32% sodium hydroxide solution in 50 ml of deionised water and 9.0 g of acrylic acid is prepared in a glass reaction apparatus with a paddle stirrer. The suspension is made up to 475 ml with deionised water and adjusted to pH 4 using 32% sodium hydroxide solution or 65% nitric acid.

A starter solution comprising 13.7 g of ammonium cerium(IV) nitrate and 1.2 g of 65% nitric acid in 25 ml of deionised water is initially introduced in a dropping funnel with pressure equalisation. The entire apparatus is rendered inert by repeated (3×) evacuation and decompression with nitrogen. The suspension in the apparatus is subsequently warmed to 55° C.

The starter solution is added to the inertised suspension with stirring at an internal temperature of 55° C. The suspension is stirred at 55° C. for 17 hours under a gentle stream of nitrogen. The reaction solution is then filtered through a glass filter frit (P2) with suction, and the gel on the frit is washed with in each case 100 ml of washing solution as follows:

8×0.5M sulfuric acid, 0.2M ascorbic acid
3× deionised water
2×1 M sodium hydroxide solution

The gel is suspended in 200 ml of 1 M sodium hydroxide solution and shaken for 20 hours, after suction filtration on the frit the gel is washed further with in each case 100 ml of washing solution as follows:

2×1 M sodium hydroxide solution
4× deionised water
5×0.5M sulfuric acid, 0.2M ascorbic acid
5× deionised water

The gel is suspended in 200 ml of deionised water and adjusted to pH 7 using 25% hydrochloric acid. The gel is stored in 20% ethanol at room temperature.

### Example 4

### Procedure for the Preparation of a Graft Copolymer from 2-Acrylamido-2-Methylpropanesulfonic Acid and Acrylic Acid (Batch 05PP131)

### Procedure:

A suspension of 140 g of filter-moist Fractogel TSK HW65 (M) (washed with dilute mineral acid and deionised water) and a solution of 33.6 g of 32% sodium hydroxide solution in 120 ml of deionised water, 46.6 g of 2-acrylamido-2-methylpropanesulfonic acid (addition with ice-cooling) and 16.2 g of acrylic acid is prepared in a glass reaction apparatus with a paddle stirrer. The suspension is made up to 400 ml with deionised water and adjusted to pH 3 using 65% nitric acid.

A starter solution comprising 2.8 g of ammonium cerium(IV) nitrate and 0.7 g of 65% nitric acid in 50 ml of deionised water is initially introduced in a dropping funnel with pressure equalisation. The entire apparatus is rendered inert by repeated (3×) evacuation and decompression with nitrogen. The suspension in the apparatus is subsequently warmed to 42° C.

The starter solution is added to the inertised suspension with stirring at an internal temperature of 42° C. The suspension is stirred at 42° C. for 5 hours and subsequently at room temperature for a further 17 hours under a gentle stream of nitrogen. The reaction solution is then filtered through a glass filter frit (P2) with suction, and the gel on the frit is washed with in each case 200 ml of washing solution as follows:

7× deionised water
8×1 M sulfuric acid, 0.2 M ascorbic acid
5× deionised water
3×1 M sodium hydroxide solution
3× deionised water
1×50 mM phosphate buffer pH 7.0
2× deionised water
2×20% ethanol/150 mM sodium chloride

The gel is stored in 20% ethanol/150 mM sodium chloride solution at room temperature.

### Example 5

### Procedure for the Preparation of a Graft Copolymer from 2-Acrylamido-2-Methylpropanesulfonic Acid and Acrylic Acid (Batch 06PP066)

### Procedure:

A suspension of 210 g of filter-moist Fractogel TSK HW65 (M) (washed with dilute mineral acid and deionised water) and a solution of 56.1 g of 32% sodium hydroxide solution in 150 ml of deionised water, 77.7 g of 2-acrylamido-2-methylpropanesulfonic acid (addition with ice-cooling) and 27.0 g of acrylic acid is prepared in a glass reaction apparatus with a paddle stirrer. The suspension is made up to 660 ml with deionised water and adjusted to pH 3 using 65% nitric acid.

A starter solution comprising 20.7 g of ammonium cerium(IV) nitrate and 7.2 g of 65% nitric acid in 90 ml of deionised water is initially introduced in a dropping funnel with pressure equalisation. The entire apparatus is rendered inert by repeated (3×) evacuation and decompression with nitrogen. The suspension in the apparatus is subsequently warmed to 55° C.

The starter solution is added to the inertised suspension with stirring at an internal temperature of 55° C. The suspension is stirred at 55° C. for 3 hours under a gentle stream of nitrogen. The reaction solution is then filtered through a glass filter frit (P2) with suction, and the gel on the frit is washed with in each case 300 ml of washing solution as follows:

7× deionised water
8×0.5 M sulfuric acid, 0.2 M ascorbic acid
5× deionised water
2×1 M sodium hydroxide solution

The gel is suspended in 600 ml of 1 M sodium hydroxide solution and shaken for 20 hours, after suction filtration on the frit the gel is washed further with in each case 100 ml of washing solution as follows:

2×1 M sodium hydroxide solution
3× deionised water
1×50 mM phosphate buffer pH 7.0
2× deionised water
2×20% ethanol/150 mM sodium chloride

The gel is stored in 20% ethanol/150 mM sodium chloride solution at room temperature.

### Example 6

### Procedure for the Preparation of a Graft Copolymer from 2-Acrylamido-2-Methylpropanesulfonic Acid and Acrylic Acid (Batch 06PP189)

Procedure see procedure for the preparation of a graft copolymer from 2-acrylamido-2-methylpropanesulfonic acid and acrylic acid (batch 06PP066). Only further washing steps with 2×0.5 M sulfuric acid, 0.2 M ascorbic acid were added.

### Example 7

### Procedure for the Coupling of Benzylamine to a Graft Copolymer Comprising 2-Acrylamido-2-Methylpropanesulfonic Acid and Acrylic Acid (Batch 06PP262)

### Procedure:

40 ml of sedimented graft copolymer comprising 2-acrylamido-2-methylpropanesulfonic acid and acrylic acid on Fractogel (batch 06PP189) are washed 8× with 40 ml of water each time and filtered with suction on a glass filter frit.

The filter-moist gel is suspended in a solution of 12.8 g of benzylamine in 32 ml of deionised water and adjusted to pH 4.7 using 32% hydrochloric acid in a glass apparatus with a paddle stirrer. After the pH has been checked and adjusted if necessary, 0.8 g of N-(3-dimethylaminopropyl)-N′-ethylcarbodiimide hydrochloride (EDC) are added.

The suspension is stirred, during which the pH is held at pH 4.7 by addition of 6% sodium hydroxide solution. After 3 hours, a further 0.8 g of EDC are added. The pH is furthermore held at pH 4.7 by addition of 6% sodium hydroxide solution and monitored for min. 1 hour.

When the reaction solution has been stirred for 17 hours, it is filtered through a glass filter frit (P2) with suction, and the gel on the frit is washed with in each case 40 ml of washing solution as follows:

10× deionised water
3×1 M sodium chloride solution
5×50 mM phosphate buffer, pH 7.0
2×20% ethanol/150 mM sodium chloride solution

The gel is stored in 20% ethanol/150 mM sodium chloride solution at room temperature.

### Example 8

### Procedure for the Coupling of Benzylamine to a Graft Copolymer Comprising 2-Acrylamido-2-Methylpropanesulfonic Acid and Acrylic Acid (Batch 06PP345)

Procedure see procedure for the coupling of benzylamine to a graft copolymer comprising 2-acrylamido-2-methylpropanesulfonic acid and acrylic acid (batch 06PP262). 0.6 g of N-(3-dimethylaminopropyl)-N′-ethylcarbodiimide hydrochloride (EDC) is added in each case.

### Example 9

### Procedure for the Coupling of Benzylamine to a Graft Copolymer Comprising 2-Acrylamido-2-Methylpropanesulfonic Acid and Acrylic Acid (Batch 06PP346)

Procedure see procedure for the coupling of benzylamine to a graft copolymer comprising 2-acrylamido-2-methylpropanesulfonic acid and acrylic acid (batch 06PP262). 1.0 g of N-(3-dimethylaminopropyl)-N′-ethylcarbodiimide hydrochloride (EDC) is added in each case.

### Example 10

### Procedure for the Preparation of a Graft Copolymer from 2-Acrylamido-2-Methylpropanesulfonic Acid and 4-Acrylamidobutyric Acid (Batch 06SW055)

### Procedure:

A suspension of 70 g of filter-moist Fractogel TSK HW65 (M) (washed with dilute mineral acid and deionised water) and a solution of 16.8 g of 32% sodium hydroxide solution in 75 ml of deionised water, 13.3 g of 2-acrylamido-2-methylpropanesulfonic acid (addition with ice-cooling) and 17.7 g of 4-acrylamidobutyric acid is prepared in a glass reaction apparatus with a paddle stirrer. The suspension is made up to 200 ml with deionised water and adjusted to pH 3 using 65% nitric acid.

A starter solution comprising 6.2 g of ammonium cerium(IV) nitrate and 0.4 g of 65% nitric acid in 25 ml of deionised water is initially introduced in a dropping funnel with pressure equalisation. The entire apparatus is rendered inert by repeated (3×) evacuation and decompression with nitrogen. The suspension in the apparatus is subsequently warmed to 55° C.

The starter solution is added to the inertised suspension with stirring at an internal temperature of 55° C. The suspension is stirred at 55° C. for 3 hours under a gentle stream of nitrogen. The reaction solution is then filtered through a glass filter frit (P2) with suction, and the gel on the frit is washed with in each case 100 ml of washing solution as follows:

5×0.5 M sulfuric acid, 0.2 M ascorbic acid
3× deionised water
4×1 M sodium hydroxide solution
5× deionised water
1×50 mM phosphate buffer pH 7.0
3× deionised water
2×20% ethanol/150 mM sodium chloride

The gel is stored in 20% ethanol/150 mM sodium chloride solution at room temperature.

### Example 11

### Procedure for the Preparation of a Graft Polymer from 4-Acrylamidobutyric Acid (Batch 05PP116)

### Procedure:

25.0 g of 32% sodium hydroxide solution is added to a solution of 20.6 g of 4-aminobutyric acid in 200 ml of deionised water at 0-5° C. in a glass reaction apparatus with a paddle stirrer. 18.2 g of acryloyl chloride and 25.0 g of 32% sodium hydroxide solution is added simultaneously from two dropping funnels with vigorous stirring at 0-5° C. The mixture is then stirred at room temperature for a further 45 minutes. The monomer solution is acidified to pH 2 using 65% nitric acid.

70 g of filter-moist Fractogel TSK HW65 (M) (washed with dilute mineral acid and deionised water) is suspended in the monomer solution. The mixture is made up to 450 ml with deionised water and adjusted to pH 2 using 65% nitric acid.

A starter solution comprising 2.7 g of ammonium cerium(IV) nitrate and 1.0 g of 65% nitric acid in 50 ml of deionised water is initially introduced in a dropping funnel with pressure equalisation. The entire apparatus is rendered inert by repeated (3×) evacuation and decompression with nitrogen. The suspension in the apparatus is subsequently warmed to 42° C.

The starter solution is added to the inertised suspension with stirring at an internal temperature of 42° C. The suspension is stirred at 42° C. for 5 hours and subsequently at room temperature for a further 17 hours under a gentle stream of nitrogen. The reaction solution is then filtered through a glass filter frit (P2) with suction, and the gel on the frit is washed with in each case 200 ml of washing solution as follows:

5× deionised water
8×0.5 M sulfuric acid, 0.2 M ascorbic acid
3× deionised water
2×1 M sodium hydroxide solution
2× deionised water

The gel is suspended in 200 ml of deionised water and adjusted to pH 7 using 25% hydrochloric acid. The gel is stored in 20% ethanol at room temperature.

### Example 12

### Procedure for the Coupling of Amines to a Graft Copolymer Comprising 2-Acrylamido-2-Methylpropanesulfonic Acid and Acrylic Acid

### Procedure:

20 ml of sedimented graft copolymer comprising 2-acrylamido-2-methylpropanesulfonic acid and acrylic acid on Fractogel (batch 06PP066 or 05PP131) are washed 8× with 20 ml of water each time and filtered with suction on a glass filter frit.

Amine solution: 5-60 mmol of amine are dissolved in 20 ml of deionised water (or DMF/deionised water 3:1) and adjusted to pH 4.7 using 32% hydrochloric acid (Table 2).

EDC solution: Dissolve 2.4 g of N-(3-dimethylaminopropyl)-N′-ethylcarbodiimide hydrochloride (EDC) in 4.8 ml of deionised water.

The filter-moist gel is suspended in the amine solution in a sealable beaker. 1.2 ml of EDC solution are then added, and the suspension is shaken at room temperature. After 3 hours, a further 1.2 ml of EDC solution are added, and the mixture is shaken for a further 17 hours.

The reaction solution is filtered through a glass filter frit with suction, and the gel on the frit is washed with in each case 20 ml of washing solution as follows:

(if desired 5×DMF)
5× deionised water
3× with 1 M sodium hydroxide solution/ethanol 2:8 (V/V)

The gel is suspended in 20 ml of 1 M sodium hydroxide solution/ethanol 2:8 and shaken for 20 hours, after suction filtration on the frit the gel is washed further with in each case 20 ml of washing solution as follows:

2×1 M sodium hydroxide solution/ethanol 2:8
3× deionised water
1×50 mM phosphate buffer pH7.0
2× deionised water
2×20% ethanol/150 mM sodium chloride solution

The gel is stored in 20% ethanol/150 mM sodium chloride solution at room temperature.

### Example 13

### Procedure for the Coupling of Benzylamine to a Graft Copolymer Comprising 2-Acrylamido-2-Methylpropanesulfonic Acid and 4-Acrylamidobutyric Acid (Batch 06SW058)

### Procedure:

20 ml of sedimented graft copolymer comprising 2-acrylamido-2-methylpropanesulfonic acid and 4-acrylamidobutyric acid on Fractogel (batch 06SW055) are washed 5× with 20 ml of water each time and 5× with 20 ml of 0.1 M 2-morpholinoethanesulfonic acid solution (MES buffer) pH 4.7 each time and filtered with suction on a glass filter frit.

6.4 g of benzylamine are dissolved in 20 ml of 0.1 M MES buffer and adjusted to pH 4.7 using 32% hydrochloric acid.

The filter-moist gel is suspended in the benzylamine solution in a sealable beaker. 0.4 g of N-(3-dimethylaminopropyl)-N′-ethylcarbodiimide hydrochloride (EDC) are added, and the suspension is shaken at room temperature. After 3 hours, a further 0.4 g of EDC are added, and the mixture is shaken for a further 17 hours.

The reaction solution is filtered through a glass filter frit with suction, and the gel on the frit is washed with in each case 20 ml of washing solution as follows:

10× deionised water
3×1 M sodium chloride solution
5×50 mM phosphate buffer pH7.0
2× deionised water
2×20% ethanol/150 mM sodium chloride solution

The gel is stored in 20% ethanol/150 mM sodium chloride solution at room temperature.

The static binding capacity of polyclonal human IgG (Gammanorm) is 30.9 mg of IgG/ml in 20 mM phosphate, 75 mM sodium chloride, pH 6.5, and 9.1 mg of IgG/ml in 20 mM phosphate, 150 mM sodium chloride, pH 6.5. The method for determining the binding capacity is described in Example 15.

### Example 14

### Procedure for the Coupling of Benzylamine to a Graft Polymer Comprising 4-Acrylamidobutyric Acid (Batch 05PP117/05PP118)

### Procedure:

20 ml of sedimented graft polymer comprising 4-acrylamidobutyric acid on Fractogel (batch 05PP116) are washed 5× with 20 ml of water each time and 5× with 20 ml of 0.1 M 3-morpholinopropanesulfonic acid solution (MPS buffer) pH 4.7 each time and filtered on a glass filter frit with suction.

Variant A: 6.4 g of benzylamine are dissolved in 20 ml of 0.1 M MPS buffer and adjusted to pH 4.7 using 32% hydrochloric acid.

The filter-moist gel is suspended in the amine solution in a sealable beaker. 0.4 g of N-(3-dimethylaminopropyl)-N′-ethylcarbodiimide hydrochloride (EDC) are added, and the suspension is shaken at room temperature. After 3 hours, a further 0.4 g of EDC are added, and the mixture is shaken for a further 17 hours.

Variant B: 1.1 g of benzylamine are dissolved in 20 ml of 0.1 M MPS buffer and adjusted to pH 4.7 using 32% hydrochloric acid.

The filter-moist gel is suspended in the amine solution in a sealable beaker. 0.07 g of N-(3-dimethylaminopropyl)-N′-ethylcarbodiimide hydrochloride (EDC) are added, and the suspension is shaken at room temperature. After 3 hours, a further 0.07 g of EDC are added, and the mixture is shaken for a further 17 hours.

The reaction solutions variant A or B are filtered through a glass filter frit with suction, and the gels on the frit are washed with in each case 20 ml of washing solution as follows:

10× deionised water
3×1 M sodium chloride solution
5×50 mM phosphate buffer pH7.0

The gels are stored in 20% ethanol/150 mM sodium chloride solution at room temperature.

The static binding capacity of polyclonal human IgG (Gammanorm) in 20 mM phosphate, 75 mM sodium chloride, pH 6.5, is 7.6 mg of IgG/ml for gel variant A and 16.8 mg of IgG/ml for gel variant B. The method for determining the binding capacity is described in Example 15.

### Example 15

### Determination of the Static IgG Binding Capacity (Microtitre Plate Format)

All gel suspensions were adjusted to a gel sediment volume of 50% using 20% of ethanol in water. A filter plate is filled with binding buffer and with in each case 20 μl of the homogenised gel suspension. The filter plate is then filtered with suction on a vacuum station.

A deep-well plate is filled with binding buffer, IgG stock solution (polyclonal human IgG Gammanorm, Octapharma) is added, and the components are mixed.

Add 200 μl of IgG solution to the gel in the filter plate, and shake the plate for 15 min on a shaker. The filter plate is filtered with suction on the vacuum station. It is washed twice with 100 μl of binding buffer each time and filtered with suction. In each case, 200 μl of elution buffer (20 mM phosphate, 1 M sodium chloride, pH 7) are then added to the filter plate, which is shaken for 5 min. The supernatant is sucked into a UV plate on the vacuum station, and the plate is measured in the photometer at 280 nm.

The IgG binding capacities per ml of gel sediment volume (IgG SBC) calculated from the eluate are listed in Table 2. The binding buffers used were 20 mM phosphate, 75 mM sodium chloride, pH 6.5, and 20 mM phosphate, 150 mM sodium chloride, pH 6.5.

The binding capacities of the separating materials from Example 12 are shown in Table 2.

### Example 16

### Determination of the Chemical Composition of the Graft Polymers

The functional groups can be cleaved off from the graft polymers which are polyacrylamide chains by acidic hydrolysis. The functional groups are liberated as amine and can be analysed quantitatively by HPLC after derivatisation by means of ortho-phthaldialdehyde and mercaptoethanol. For calibration, the commercial amines are used or the monomer used in the synthesis, which must then be hydrolysed like the graft polymer.

1000 μl of 5 M hydrochloric acid are added to 10 mg of dry gel, the mixture is treated in an ultrasound bath and subsequently heated at 125° C. for 10 hours in a 1 ml pressure container.

After cooling to room temperature, the pressure container is opened, and about 200 μl of supernatant are pipetted off and centrifuged (8000 rpm) for 5 min.

40 μl of the clear supernatant are neutralised using 176 μl of 1 M sodium hydroxide solution, and 325 μl of 0.5 M borate buffer pH 9.5 and 119 μl of acetonitrile/water 8:2 (V/V) are added, and the components are mixed. 100 μl of OPA reagent, which is prepared from 100 mg of ortho-phthalaldehyde, 9 ml of methanol, 1 ml of 0.5 M borate buffer pH 9.5 and 100 μl of mercaptoethanol, is added, and the mixture is shaken vigorously. After a reaction time of 2 minutes, the sample is analysed by HPLC (UV detection 330 nm).

The number of charged groups is determined by titration. To this end, the gel is shaken with 0.5 M hydrochloric acid and washed with 0.001 M hydrochloric acid. The gel charged in this way is titrated with 0.1 M sodium hydroxide solution. The gel is subsequently washed and dried. The equivalence points are determined by formation of the first derivative.

The results are listed in Table 4.

### Example 17

### Determination of the Dynamic IgG Binding Capacity

Columns were packed with 1 ml of contents. Proteo-Cart columns with a bed depth of 19 mm and 20% compression and Superformance columns with a bed depth of 13 mm and 10% compression. The column were charged with an IgG solution having a content of 1 g/l in buffer A (prepared from polyclonal human IgG Gammanorm, Octapharma) to a breakthrough of 10%. The flow rate here was selected so that the contact time in the column is 4 min. After rinsing with buffer A, the column was eluted with buffer B.

Buffer A: 25 mM phosphate, 150 mM sodium chloride, pH 6.5
Buffer B: 25 mM phosphate, 1 M sodium chloride, pH 6.5
or
Buffer A′: 25 mM phosphate, 150 mM sodium chloride, pH 5.5
Buffer B′: 25 mM phosphate, 1 M sodium chloride, pH 5.5
or
Buffer A″: 25 mM phosphate, 150 mM sodium chloride, pH 5.5
Buffer B″: 50 mM TRIS buffer, 2 M sodium chloride, pH 9.0

The results are listed in Table 4.

### Example 18

### Binding Experiment with Monoclonal Antibody

A 1 ml capacity Proteo-Cart column (Merck KgaA) is packed with a separating material (06PP343), prepared in accordance with Example 7 (17% compression), and equilibrated with 25 mM phosphate, 150 mM sodium chloride, pH 5.5 (about 12 mS/cm). A sample comprising 20 mg of chimeric, monoclonal antibody (as described in Clinical Cancer Research 1995, 1, 1311-1318, dissolved in 25 mM phosphate, 150 mM sodium chloride, pH 5.5) is applied to the column at a flow rate of 0.2 ml/min. The elution is carried out with a solution comprising 25 mM phosphate, 1 M sodium chloride at a pH 5.5. The subsequent recovery of the antibody after elution was 98% in the experiments carried out.

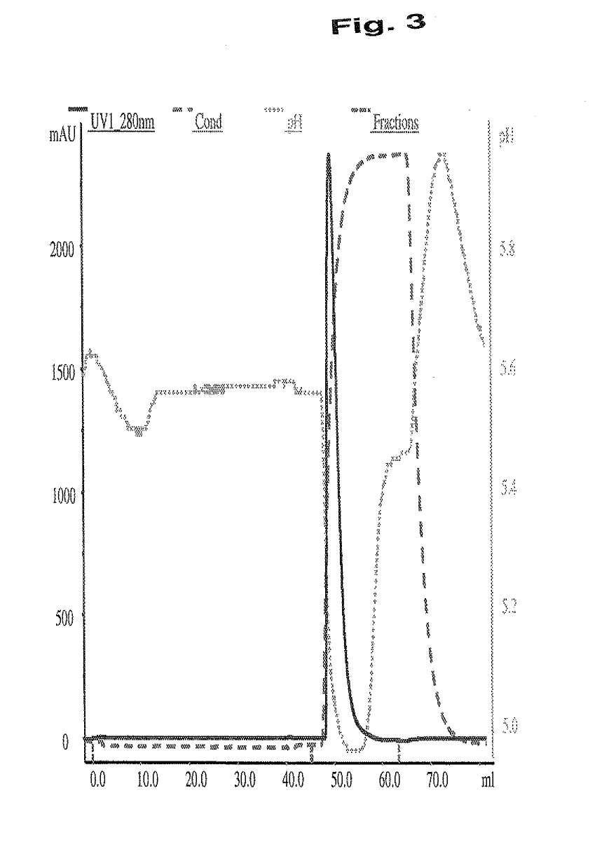

The chromatogram is shown in FIG. 3.

### Example 19

### Size Exclusion Chromatography

The distribution coefficient Kd of pullulanes having various molecular weights, depicted in FIG. 2 through their viscosity radius, was determined experimentally by isocratic experiments at three salt concentrations (0, 0.1 and 1.0 M sodium chloride) for a graft polymer comprising acrylamido-2-methylpropanesulfonic acid and acrylic acid before (Fractogel SO3/COO) and after coupling of benzylamine (Fractogel SO3/COO/benzyl).

TABLE 2
Coupling of amines to a graft copolymer comprising 2-acrylamido-2-methylpropanesulfonic acid and acrylic acid,
static binding capacity (SB) of polyclonal human IgG (Gammanorm) at pH 6.5 and 75 or 150 mM sodium chloride per ml of
gel sediment.

| | | | Amine | | SB 75 mM NaCl | SB 150 mM NaCl |
|---|---|---|---|---|---|---|
| Batch | Precursor | Solvent | mmol | Amine(s) (ratio) | mg of IgG/ml | mg of IgG/ml |
| SO3^{[1]} | None | | | | 6.4 | 0.3 |
| COO^{[2]} | None | | | | 1.2 | 0.2 |
| 05PP131^{[3]} | None | | | | 1.5 | 0.3 |
| 05PP157 | 05PP131 | Water | 10 | 4-Methoxybenzylamine | 16.6 | Not determined |
| 05PP143 | 05PP131 | Water | 60 | Phenoxyethylamine | 17.4 | Not determined |
| 05PP158 | 05PP131 | Water | 10 | 4-Fluorobenzylamine | 17.4 | Not determined |
| 06PP069 | 06PP066 | DMF/water | 60 | Octylamine | 20.2 | 5.2 |
| 05PP152 | 05PP131 | Water | 5 | Phenacylamine hydrochloride | 23.4 | Not determined |
| 05PP151 | 05PP131 | Water | 30 | Aniline | 26.5 | Not determined |
| 06PP080 | 06PP066 | DMF/water | 60 | Napthylmethylamine | 27.9 | 11.4 |
| 06PP054 | 06PP066 | Water | 60 | Benzylamine/tyramine (90:10) | 28.1 | 12.5 |
| 05PP132 | 05PP131 | Water | 60 | Benzylamine | 30.2 | Not determined |
| 06PP051 | 06PP066 | Water | 60 | Benzylamine/ethanolamine (90:10) | 32.7 | 12.9 |
| 06PP119 | 06PP066 | Water | 60 | Benzylamine | 37.9 | 20.4 |
| 06PP118 | 06PP066 | DMF/water | 60 | Tryptamine | 42.3 | 25.4 |
| 06PP086 | 06PP066 | Water | 60 | Phenylethylamine | 45.5 | 18.1 |

^{[1]}Commercially available Fractogel ® EMD SO₃⁻ (M),
^{[2]}Commercially available Fractogel ® EMD COO⁻ (M),
^{[3]}Graft copolymer before coupling reaction with hydrophobic amine.

TABLE 3
Dynamic binding capacity (DB) of polyclonal human IgG (Gammanorm) at 150 mM sodium chloride
and pH 5.5 or pH 6.5 per ml of packed gel and chemical composition of the graft polymers.

| | DB pH | | | | | |
|---|---|---|---|---|---|---|
| | 6.5 mg | DB^{[1]} pH 5.5 | DB^{[2]} pH 5.5 | SO3 | Benzyl | Charged groups |
| | of | (recovery) | (recovery) | groups | groups | (titration) |
| Batch | IgG/ml | mg of IgG/ml | mg of IgG/ml | μmol/g | μmol/g | μmol/g |
| Fractogel ® EMD SO₃⁻ (M) | 1.1 | 0.4 (n.d.) | n.d. | | | |
| Fractogel ® EMD COO⁻ (M) | 0.5 | 0.6 (n.d.) | n.d. | | | |
| 05SW136 | 1.4 | 28.0 (96%) | n.d. | 240 | 422 | 393 |
| 06SW297 | 0.9 | 42.9 (83%) | 50.5 (96%) | | 122 | 2016 |
| 06SW085 | n.d. | 34.7 (93%) | 36.9 (98%) | 107 | 187 | 497 |
| 06PP262 | 1.2 | 68.1 (82%) | 76.1 (93%) | 521 | 467 | 1366^{[3]} |
| 06PP345 | 0.5 | 15.7 (85%) | 22.7 (100%) | 657 | 353 | 1480^{[3]} |
| 06PP346 | 1.3 | 61.2 (77%) | 67.4 (89%) | 582 | 530 | 1303^{[3]} |

^{[1]}Elution with buffer B′ at pH 5.5
^{[2]}Elution with buffer B″ at pH 9.0
^{[3]}Calculated from the titration result of the precursor (06PP189 with 1833 μmol/g or 06PP292 with 1963 μmol/g) and the benzyl group density
n.d. not determined

1. Separating materials for ion exchange chromatography based on hydroxyl-containing base supports, to the surfaces of which copolymers are covalently bonded, wherein
a) the base support contains aliphatic hydroxyl groups,
b) the covalently bonded copolymers are bonded to the support via a terminal monomer unit,
c) the copolymers comprise at least two different monomer units
d) the monomer units are linked in a linear manner,
e) the copolymer comprises at least one monomer unit which carries a negative charge in the form of a sulfonic acid or carboxylic acid and in addition contains ester or amide groups and alkyl and/or alkylene groups and in total a maximum of 8 C atoms, but no aryl groups, or
which carries a negative charge in the form of a sulfonic acid or carboxylic acid and in addition contains alkyl and/or alkylene groups, but no aryl groups,
f) the copolymer comprises at least one monomer unit which carries, as hydrophobic group, a straight-chain or branched alkyl having 4 to 18 C atoms or corresponding aryl groups and contains ester or amide groups, and
g) the ratio of the monomer units having a negative charge to the monomer units containing a hydrophobic group is in a range between 99:1 to 10:90.

2. Separating materials according to claim 1, wherein
a) the base support contains aliphatic hydroxyl groups,
b) the covalently bonded copolymers are bonded to the support via a terminal monomer unit,
c) the copolymers comprise at least two different monomer units
d) the monomer units are linked in a linear manner,
e) the copolymer comprises at least one monomer unit having a negative charge, either of the general formula (1) 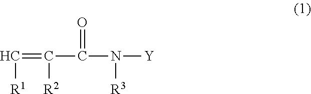
in which
R¹, R² and Y, independently of one another,
denote H or CH₃,
R³ denotes R⁴—SO₃M or R⁴—COOM,
R⁴ denotes straight-chain or branched alkylene having 2 to 4 C atoms and
M denotes H, Na, K or NH₄,
or of the general formula (2) 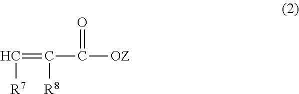
in which
R⁷ and R⁸, independently of one another,
denote H or CH₃, or
R⁷ denotes COOM if Z=M and R⁸=H,
Z denotes either M, R⁴—COOM or R⁴—SO₃M, where
R⁴ denotes straight-chain or branched alkylene having 2 to 4 C atoms,
and
M denotes H, Na, K or NH₄,
or at least in each case one monomer unit of the general formula 1 and of the general formula (2) and
f) the copolymer comprises at least one monomer unit containing a hydrophobic group of the general formula 1, which imparts a hydrophobic character on the copolymer, in which
R¹ denotes H or COOM,
R² denotes H or CH₃,
Y and R³ denote straight-chain or branched alkyl having up to 18 C atoms,
in which Y and R³ together carry at least 6 C atoms,
or
Y denotes H
and
R³ denotes straight-chain or branched alkyl having 6 to 18 C atoms or
Y denotes H
and
R³ denotes aryl or R⁶-aryl
or
Y denotes H or CH₃
and
R³ denotes R⁴—CONHX,
X denotes straight-chain or branched alkyl having 6 to 18 C atoms, aryl or R⁶-aryl
R⁴ denotes straight-chain or branched alkylene having 2 to 4 C atoms
R⁶ denotes a straight-chain or branched alkylene having 1 to 4 C atoms, in which a methylene group may be replaced by O and may be substituted by COOM
and
M denotes H, Na, K or NH₄
or a corresponding monomer unit of the general formula (2),
in which
R⁷ denotes H,
R⁸ denotes H or CH₃,
Z denotes straight-chain or branched alkyl having 4 to 18 C atoms,
aryl, R⁶-aryl or R⁴—CONHX,
X denotes straight-chain or branched alkyl having 6 to 8 C atoms, aryl, R⁶-aryl,
and
R⁶ denotes a straight-chain or branched alkylene having 1 to 4 C atoms
and
g) the ratio of the monomer units having a negative charge to the monomer units containing a hydrophobic group is in a range between 99:1 to 10:90.

3. Separating materials according to claim 1, wherein
c) the copolymers comprise at least two different monomer units,
e) the copolymer comprises at least one monomer unit having a negative charge from the series 2-acrylamido-2-methylpropanesulfonic acid, 2-acrylamidoethanesulfonic acid, carboxymethylacrylamide carboxyethylacrylamide, carboxypropylacrylamide, carboxymethlymethacrylamide, carboxyethlymethacrylamide, carboxypropylmethacrylamide, maleic acid, acrylic acid and methacrylic acid and
f) the copolymer comprises at least one monomer unit containing a hydrophobic group 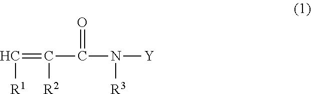
in which
R¹ denotes H,
R² denotes H or CH₃,
Y denotes H
and
R³ denotes aryl or R⁶-aryl,
or
Y denotes H or CH₃
and
R³ denotes R⁴—CONHX where
X denotes aryl or R⁶-aryl,
R⁴ denotes methylene, ethylene, propylene and
R⁶ denotes a straight-chain or branched alkylene having 1 to 4 C atoms, in which a methylene group may be replaced by O and may be substituted by COOM
and
M denotes H, Na, K or NH₄.

4. Separating materials according to claim 1, wherein
c) the copolymers comprise at least two different monomer units,
e) the copolymer comprises at least one monomer unit having a negative charge from the series 2-acrylamido-2-methylpropanesulfonic acid, 2-acrylamidoethanesulfonic acid, carboxymethylacrylamide carboxyethylacrylamide, carboxypropylacrylamide, carboxymethlymethacrylamide, carboxyethlymethacrylamide, carboxypropylmethacrylamide, maleic acid, acrylic acid and methacrylic acid and
f) the copolymer comprises at least one monomer unit containing a hydrophobic group of the general formula (1) 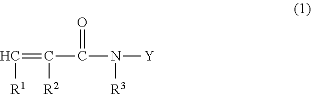
in which
R¹ denotes H,
R² denotes H or CH₃,
Y denotes H
and
R³ denotes phenyl, benzyl, phenylethyl or phenoxyethyl,
or
Y denotes H or CH₃
and
R³ denotes R⁴—CONHX where
X denotes phenyl, benzyl, or phenylethyl,
and
R⁴ denotes methylene, ethylene, propylene, acryloylphenylglycine or acryloylphenylalanine.

5. Separating material according to claim 1, wherein
a) the copolymer comprises 2-acrylamido-2-methylpropanesulfonic acid or/and 2-acrylamidoethanesulfonic acid as monomer unit having a negative charge,
b) the ratio of the monomer units having a negative charge to the monomer units containing a hydrophobic phenyl, benzyl or phenylethyl group is in a range between 70:30 to 30:70.

6. Separating material according to claim 1, wherein
a) the copolymer comprises acrylic acid or/and methacrylic acid as monomer unit having a negative charge, and
b) the molar ratio of the monomer units having a negative charge to the monomer units containing a hydrophobic phenyl, benzyl or phenylethyl group is in a range between 95:5 to 70:30.

7. Separating material according to claim 1, wherein
a) the copolymer comprises a monomer from the series 2-acrylamido-2-methylpropanesulfonic acid and 2-acrylamidoethanesulfonic acid as monomer unit having a negative charge and
b) a monomer from the series acrylic acid and methacrylic acid, and
c) the molar ratio of the monomer units having a negative charge to the monomer units containing a hydrophobic phenyl, benzyl or phenylethyl group is in a range between 95:5 to 30:70.

8. Process for the preparation of separating materials according to claim 1, wherein at least one monomer unit containing a functional group having a negative charge is graft-polymerised with at least one monomer unit containing a hydrophobic group, and optionally with a neutral monomer having hydrophilic properties, onto a hydroxyl-containing inorganic, organic or hybrid support material in a one- or multistep reaction.

9. Process according to claim 8, wherein at least one monomer unit containing a functional group having a negative charge are dissolved in dilute acid with at least one monomer unit containing a hydrophobic group, and optionally with a neutral monomer having hydrophilic properties, with addition of a cosolvent from the series acetone, dimethylacetamide, dimethylformamide, dioxane, tetrahydrofuran in the presence of cerium(IV) ions and graft-polymerised onto a hydroxyl-containing base support.

10. Process for the preparation of separating materials according to claim 8, wherein
a) at least one monomer containing carboxyl group of the general formula (1) 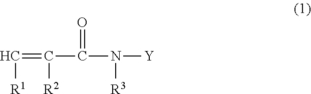
in which
R¹, R² and Y, independently of one another,
denote H or CH₃,
R³ denotes R⁴—COOM and
R⁴ denotes straight-chain or branched alkylene having 2 to 4 C atoms and
M denotes H, Na, K or NH₄,
and/or a monomer containing carboxyl group of the general formula (2) 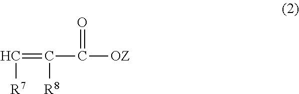
in which
R⁷ and R⁸, independently of one another,
denote H or CH₃, or
R⁷ denotes COOM if Z=M and R⁸=H,
Z denotes either M or R⁴—COOM where
R⁴ denotes straight-chain or branched alkylene having 2 to 4 C atoms,
and
M denotes H, Na, K or NH₄,
optionally together with a water-soluble monomer, is graft-polymerised onto a hydroxyl-containing inorganic, organic or hybrid support material, and
b) some of the graft-polymerised carboxyl groups are subsequently converted into amide groups by coupling to an amine.

11. Process according to claim 10 for the preparation of separating materials wherein
a) at least one monomer containing carboxyl group of the general formula (1) 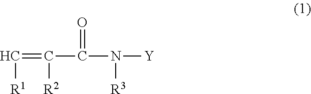
in which
R¹, R² and Y, independently of one another, denote H or CH₃,
R³ denotes R⁴—COOM,
R⁴ denotes straight-chain or branched alkylene having 2 to 4 C atoms and
M denotes H, Na, K or NH₄,
and/or of the general formula (2) 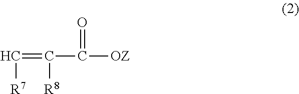
in which
R⁷ and R⁸, independently of one another, denote H or CH₃,
or
R⁷ denotes COOM if Z=M and R⁸=H
Z denotes M or R⁴—COOM
R⁴ denotes straight-chain or branched alkylene having 2 to 4 C atoms,
and
M denotes H, Na, K or NH₄,
optionally together with a further water-soluble monomer, is dissolved in water so that the proportion of negatively charged groups is 1 to 100 mol % in relation to the total amount of monomer,
b) the resultant solution is mixed with the support material in such a way that 0.05 to 100 mol of total monomer are employed per litre of sedimented support material,
c) cerium(IV) salt dissolved in mineral acid is added to the resultant suspension, causing a pH in the range from 0-5 to arise, and a cerium(IV) concentration of 0.00001-0.5 mol/l, preferably 0.001-0.1 mol/l, and
d) the reaction mixture is graft-polymerised within a time of 0.5 to 72 hours and
e) an amine or an amine mixture is employed for the modification of the graft-polymerised carboxyl groups by coupling, and
f) that the total amount of amine employed is in a molar ratio of 0.01 to 100:1 to the carboxyl groups bonded to the support and is converted into amide groups in the presence of a coupling reagent, which is employed in a molar ratio of 0.01:1 to 20:1 to the charged groups bonded to the support, and
g) an alkyl-, aryl- or arylalkylamine having 6 to 18 C atoms from the group aniline, benzylamine, 4-fluorobenzylamine, 4-methoxybenzylamine, napthylmethylamine, phenacylamine, phenylethylamine, phenoxyethylamine, tryptamine or tyramine as free amine or as hydrochloride is employed for the coupling.

12. Chromatography column, containing a separating material according to claim 1.

13. A method of performing column chromatography comprising separating materials in a chromatography column according to claim 12.

14. A method for removing biopolymers from liquid media, comprising contracting the separating material according to claim 1 with said liquid media.

15. A method according to claim 14, wherein the biopolymer is dissolved in an aqueous liquid which has an electrolytic conductivity of 1 to 20 mS/cm and a pH of greater than 4.

16. A method according to claim 14, wherein, the biopolymer bonded to the separating material by interaction with the ionic groups and optionally hydrophobic groups is desorbed either by
a) increasing the ion strength and/or
b) by modifying the pH in the solution
and/or
c) through the use of an eluent having a different polarity to that of the adsorption buffer.
